(19) United States
(12) Patent Application Publication
(10) Pub. No.: US 2025/0136029 A1
(43) Pub. Date: May 1, 2025

(54) Impact-Absorbing Cross Member

(71) Applicant: ACPS Automotive GmbH, Ingersheim (DE)

(72) Inventor: Ralf Pietschmann, Loechgau (DE)

(73) Assignee: ACPS Automotive GmbH, Ingersheim (DE)

(21) Appl. No.: 18/921,438

(22) Filed: Oct. 21, 2024

(30) Foreign Application Priority Data
Oct. 30, 2023 (DE) 10 2023 129 949.2

(51) Int. Cl. B60R 19/34; B60D 1/48; B60R 19/14; B60R 19/38

(52) U.S. Cl. CPC B60R 19/34; B60R 19/14; B60R 19/38; B60D 1/48

(57) ABSTRACT

In order to provide an impact-absorbing cross member which is mountable under a bumper unit of a vehicle body on a rear region thereof, wherein the cross member extends in a transverse direction running parallel to the bumper unit and has support elements arranged at the ends for support on side regions of the vehicle body, and wherein the support elements are connected to one another by a central unit of the cross member, which is capable of absorbing a side impact without the central unit being damaged and without the vehicle body also being damaged, it is proposed that side impact elements are provided on both sides of the central unit and are arranged so as to be movable relative thereto and are supported on the support elements of the cross member by means of impact energy absorption elements.

### CROSS-REFERENCE TO RELATED PATENT APPLICATIONS

This Patent application claims priority to German Patent Application No. DE 10 2023 129 949.2, filed Oct. 30, 2023, the entire teachings and disclosure of which are incorporated herein by reference thereto.

### BACKGROUND OF THE INVENTION

The present disclosure relates to the subject matter disclosed in German application number 10 2023 129 949.2 of 30 Oct. 2023, which is incorporated herein by reference in its entirety and for all purposes.

The invention relates to an impact-absorbing cross member which is mountable under a bumper unit of a vehicle body on a rear region thereof, wherein the cross member extends in a transverse direction running parallel to the bumper unit and has support elements arranged at the ends for support on side regions of the vehicle body, and wherein the support elements are connected to one another by a central unit of the cross member.

Such cross members are known from the prior art.

In accordance with an embodiment of the invention, an impact-absorbing cross member is provided, which is capable of absorbing a side impact without damaging the central unit and without also damaging the vehicle body.

For example, such a rear oblique impact is defined by an RCAR crash requirement, wherein the requirement is that the impact-absorbing cross member should not damage the vehicle body shell structure.

### SUMMARY OF THE INVENTION

In an impact-absorbing cross member of the type described at the outset, in accordance with an embodiment of the invention, provision is made that side impact elements are arranged on both sides of the central unit so as to be movable relative thereto, said side impact elements being supported on the support elements of the cross member by means of impact energy absorption elements.

The advantage of this is considered to be the fact that it makes it possible to absorb the impact energy of such a rear oblique collision by means of the side impact elements and the impact energy absorption elements supporting them, without damaging the cross member with the support elements and the central unit and thus also without damaging the vehicle body shell structure.

In order to be able to optimally absorb the impact energy, it is preferable that the impact energy absorption elements have pre-formed wall elements extending in a direction of extent from the respective support element to the corresponding side impact element, which wall elements are foldable for impact energy absorption, wherein the folding makes it possible to optimally absorb the impact energy.

In particular, it is provided here that wall elements of the impact absorption elements have a pre-stamping in such a way that they fold along fold lines for impact energy absorption and run transversely to the direction of extent of the impact energy absorption elements from the support elements to the side impact elements.

By pre-stamping the impact energy absorption elements in this way, the energy absorption and thus also the deformation of the impact energy absorption elements can be predetermined in a particularly advantageous way in order to create defined conditions for the energy absorption.

A structurally favorable solution is that the impact energy absorption elements are configured to at least partially surround a central axis parallel to the direction of extent, so that, likewise, the impact energy can be advantageously absorbed by the structure partially surrounding the central axis with a predefinable pre-forming of the impact energy absorption elements.

It is even better if the impact energy absorption elements have a closed peripheral form around the central axis parallel to the direction of extent in order to be able to absorb as much impact energy as possible with as definable a deformation as possible.

Furthermore, in order to achieve a defined deformation of the impact energy absorption elements, it is advantageous if the impact energy absorption elements for supporting the side impact elements have an impact-side cross-sectional area that is smaller than a support-side cross-sectional area provided for the support on the support elements.

This makes it particularly easy to specify a defined deformation behavior, in particular approximately parallel to the central axis.

The deformation behavior of the impact energy absorption elements can be predefined even better if they are configured to taper in their direction of extent from the respective support element to the respective side impact element.

This cone-like structure makes it possible to predefine the overall deformation of the impact energy absorption elements in such a way that, in the event of a crash, there is as little sideways movement as possible in relation to the direction of extent and/or the central axis.

In conjunction with the previous explanation of the solution according to the invention, it was only specified that the side impact elements are supported on the support elements by means of the impact energy absorption elements.

The solution according to the invention is particularly advantageous if the side impact elements, in a pre-impact position, are supported movably relative to the central unit.

This type of support on the central unit makes it possible to influence the movement of the side impact elements in the event of a crash so that they move as little as possible in the vertical and horizontal direction relative to the central unit and thus also contribute to a predefinable deformation of the impact energy absorption elements.

The movable support of the side impact elements relative to the central unit serves not to damage the central unit in the event of a crash, but merely to guide the movement of the side impact elements.

It is particularly advantageous if the side impact elements are movably supported for support on the central unit by means of an articulated connection, comprising in particular an extension on the one hand and a receptacle for the extension on the other.

This articulated connection of the side impact elements relative to the central unit makes it possible in particular to guide the side impact elements in as defined a manner as possible.

In particular, the embodiment of the articulated connection by means of an extension and a receptacle receiving this extension also makes it possible to create sufficient clearance for movement for the side impact elements in the event of a crash, in particular without damaging the central unit.

In principle, the extension and the receptacle could be formed in such a way that the extension is only supported in the receptacle at the start of a crash and is then released from the receptacle.

However, an even more advantageous solution is that the respective extension, in the pre-impact position, is secured in the receptacle against leaving the receptacle, so that the extension initially remains in the receptacle at least at the start of the crash.

With regard to the configuration of the side impact elements themselves, no further details have been provided in conjunction with the previous explanation of the individual exemplary embodiments.

Thus, an advantageous solution provides that each of the side impact elements extends in the transverse direction over at least a quarter of the total extent of the cross member in the transverse direction, so that the cross member is capable of absorbing a side impact by one of the side impact elements over an appreciably large distance.

It is even more favorable if the extent of the side impact elements in the transverse direction extends over more than a quarter of the total extent of the cross member in the transverse direction.

Furthermore, in order to have sufficient space available for the central unit, it is provided that each of the side impact elements in the transverse direction extends over a maximum of half the total extent of the cross member in the transverse direction.

Preferably, the extent of the side impact elements in the transverse direction is less than half of the total extent of the cross member in the transverse direction, for example a maximum of one third of the total extent of the cross member.

No further details have yet been provided with regard to the configuration of the side impact elements.

Preferably, the side impact elements have beads running in the transverse direction in order to achieve improved stability of the side impact elements.

No further details have been provided with regard to the extent of the central unit in this context.

It is therefore preferable for the side impact elements to extend adjacent to a central portion of the central unit, which runs at a maximum spacing from a support contour for the cross member defined by the side regions of the rear region of the vehicle body.

It is particularly favorable if the central unit extends at a short spacing from a support contour predefined by the position of the support elements following on from the central portion, so that in the event of a crash there is sufficient space for the side impact elements to move in the direction of the support contour of the cross member.

In order furthermore to create sufficient space for the impact energy absorption elements to deform in the event of a crash, it is provided that the support elements have support surfaces for the impact energy absorption elements and that said support surfaces are less than 10 mm away from the body support surfaces of the support elements by which these are supported on the side regions of the vehicle body.

This solution therefore requires the support elements to be formed so as to be extremely low-profile.

In the simplest case, the support elements can be formed by a part similar in shape to a plate.

Furthermore, it is preferable that the support surfaces of the impact energy absorption elements and the body support surfaces of the support elements are arranged on opposite sides of the support elements.

It is particularly favorable if the support surfaces of the support elements for the impact energy absorption elements and the body support surfaces of the support elements are arranged on opposite sides of a base plate of the support elements.

Furthermore, to stabilize the support elements, it is advantageous if the support elements have stabilizing elements outside the support surfaces for the impact energy absorption elements, which stabilizing elements improve the dimensional stability and thus significantly improve the dimensional stability of the support elements, especially in the case of a base plate.

Preferably, it is provided here that the stabilizing elements have webs extending transversely to the support surface.

Such webs can be made of flat material or of shaped or bead-like material.

It is particularly advantageous here if the webs are formed from wall portions of the support elements, as these can be realized very easily.

It is particularly expedient if the stabilizing elements are integrally molded on the base plate.

A particularly favorable solution also provides that the webs extending transversely to the support surfaces extend starting from a side facing away from the central body in the direction of the central unit with increasing extent transversely to the support surface, i.e., extend away from the support surface.

This makes it easy to create stable structures.

A particularly advantageous solution is that the stabilizing elements extending transversely to the support surface are formed integrally with the base plate forming the support surface and the body support surface, so that a stable structure can be created with little manufacturing effort.

In principle, the individual stabilizing elements can be independent of each other. However, a particularly stable structure can be achieved if at least some of the stabilizing elements, in particular at least three of the stabilizing elements, are connected to each other.

In conjunction with the previous explanation of the individual exemplary embodiments, no further details were provided with regard to the configuration of the central unit.

In principle, the central unit could be formed by two supports that run at a spacing from each other.

However, a particularly favorable solution is for the central unit to comprise a box-shaped structure.

The advantage of such a box-shaped structure is that it is both lightweight and highly rigid in order to achieve the greatest possible stability in the region of the central unit.

It is particularly advantageous if some of the stabilizing elements of the support elements are connected to walls of the box-shaped structure of the central unit.

This is a particularly advantageous way of creating a stable connection between the support elements and the central unit.

In particular, it is advantageous here if the interconnected stabilizing elements are connected to walls of the box-shaped structure in order to thus create a multiple connection between the support elements and the box-shaped structure of the central unit.

No further details have yet been provided regarding the configuration of the box-shaped structure.

One advantageous solution is that the box-shaped structure of the central unit, viewed in the direction of travel, has a wall facing the vehicle and a wall facing away from the vehicle, which in particular run at a spacing from each other.

Furthermore, it is preferable for the box-shaped structure of the central unit to have a wall facing away from the roadway.

Alternatively or in addition to this, it is preferable for the box-shaped structure of the central unit to have a wall facing the roadway.

It is particularly advantageous if the wall facing away from the vehicle, the wall facing the vehicle, the wall facing the roadway and the wall facing away from the roadway each have their longitudinal sides in contact with one another and are fixedly connected, in particular welded, to one another, thus forming a closed support structure.

A further advantageous embodiment provides for the box-shaped structure to be provided with a stiffening in a central region.

In particular, the box-shaped structure is provided with a stiffening at least in the region of the wall facing the vehicle or the wall facing away from the vehicle or both walls in a central region, as the central region is not subject to any great stiffening due to the opening in the wall facing the roadway and, for example in the case of an additional mounted attachment element, is exposed to the greatest forces which are to be transmitted to the support elements and from these to the rear of the vehicle.

In order to save weight in the region of the box-shaped structure, it is preferably provided that at least one wall thereof is provided with at least one cut-out in order to reduce its weight.

Such cut-outs in the walls of the box-shaped structure can be provided in one or more of the walls, preferably in each of the walls.

In order to prevent the torsional and flexural strength of the box-shaped structure from suffering significantly as a result of the cut-outs, it is preferable for the at least one cut-out to have an extent in each direction of its planar extent that is at most twice, better still at most one and a half times, and even better still one times the areal extent of a surface region surrounding it in the respective direction.

Furthermore, when cut-outs are provided, it is expedient to ensure that there are wall regions between the cut-outs of which the extent in each direction of their areal extent is at least 0.5 times the extent of the cut-outs in the respective direction.

The torsional and flexural strength of the box-shaped structure can be ensured by such sufficiently wide wall regions or cross members.

In particular, it is necessary that the above-mentioned surface regions between the cut-outs are also present in all walls in which also the above-mentioned cut-outs are located.

It is particularly advantageous here if the surface regions located in the transverse direction between the cut-outs run at least partially parallel and/or transverse to the vertical longitudinal center plane and thus contribute to the tensile and shear stiffness of the respective wall, particularly in the region of the respective wall.

Furthermore, it is preferable that the at least one cut-out has an outer contour with a substantially round and/or oval basic shape.

Such a basic shape of the recess makes it possible to avoid stresses building up in the edge regions of the cut-outs.

Alternatively, however, it is also possible for the cut-outs to have an outer contour with a triangular shape as the basic shape, in particular with rounded corner regions, wherein such triangular cut-outs have the advantage that the areas lying between them can be arranged in such a way that they extend in particular at an angle to the vertical longitudinal center plane, i.e., both transversely and parallel to the vertical longitudinal center plane, and thus also improve the tensile and shear stiffness of the individual walls.

The rounded corner regions in particular serve also to avoid stress peaks in the corner regions.

In the exemplary embodiments described so far, the cut-outs serve in particular to save weight, wherein this is relevant if the walls of the box-shaped structure have a relatively large thickness of the sheet material, for example 4 mm or more with a tensile strength of 400 MPascal or less. In this case, weight can be saved by the cut-outs with insignificant losses in terms of torsional and flexural strength.

Another advantageous solution is that the at least one cut-out has an edge region which, in relation to the surface region surrounding said cut-out, is raised relative to this surface region.

Raising edge regions at a cut-out in this way makes it possible to significantly improve the torsional and flexural rigidity of the box-shaped structure and thus also of the individual walls, so that it is possible to reduce the material thickness of the walls if necessary, for example to less than 5 mm or even better 4 mm or less.

In this case, for example, the tensile strength of the sheet material can be between 400 MPascal and 800 MPascal.

In particular, it is provided that the edge region runs closed around the respective cut-out and thus has the stabilizing effect of a closed ring body running around the respective cut-out.

It is particularly advantageous if the raised edge regions have a height transverse to surface regions surrounding them that is at least twice the material thickness of the surrounding surface region, so that the surrounding surface region, which in particular is closed, results in increased torsional and anti-twisting strength of the respective wall.

In order to also increase the stability of the wall, it is preferable to provide that at least part of the wall has increased rigidity against deformation as a result of having been reshaped, in particular reshaped starting from a flat material.

In the simplest case, such reshaping can consist of providing the respective wall with curvatures or bends that can extend in a wide variety of directions.

It is particularly advantageous if at least one of the walls of the box-shaped structure has a curvature running transverse to a vertical longitudinal center plane.

Such a curvature can, for example, be a curvature or a bend with a bending line, for example parallel to the vertical longitudinal center plane or in a transverse direction thereto.

Another advantageous solution is that at least two walls are formed as a one-piece part by reshaping.

In this case, for example, the bending line of the reshaping can extend in the transverse direction to the vertical longitudinal center plane.

However, it is also conceivable to additionally stabilize the bending line of the reshaping in portions by reshaping it transversely to this bending line.

An advantageous exemplary embodiment provides that at least one of the walls and the wall adjoining it are parts of a profile body, for example an angle profile or U-profile.

A particularly advantageous solution provides that at least one of the walls has at least one stamped bead.

Depending on its orientation, such an stamped bead can provide stability in a wide variety of directions.

Thus, an advantageous solution provides that at least one of the walls, in particular the wall facing the vehicle and/or the wall facing away from the vehicle, has at least one stamped bead which extends in the transverse direction to the vertical longitudinal center plane in order to be able to optimally transmit tensile and compressive forces in the direction of the rear of the vehicle or away from the rear of the vehicle to the support elements.

Another advantageous solution provides that, additionally or alternatively, at least one of the walls has successively arranged stamped beads in the transverse direction of the box-shaped structure, which in particular improve the torsional and deflection rigidity of the box-shaped structure.

Such beads preferably run inclined to the vertical longitudinal center plane.

All beads here can be inclined in the same or alternating directions.

Alternatively, an advantageous solution is for successive beads to run transversely to each other in the transverse direction to the vertical longitudinal center plane and thus, in particular, the beads are arranged in the transverse direction similarly to a zigzag line.

This type of course of the beads makes it possible to improve the deflection rigidity of the walls.

The provision of beads makes it possible in particular to use high-strength sheet material, for example with a tensile strength of 800 MPascal or more, with a thickness of 3 mm or less, and thus to reduce the weight of the vehicle attachment unit.

No further details have yet been provided with regard to the connection of the walls themselves.

For example, one advantageous solution is that at least one of the wall elements protrudes over the other wall element with a web region in the region of a connection between two of the walls.

Such a solution has the advantage that the web region contributes to a further advantageous stiffening of the respective wall element forming the web region, since its extent in the direction with which the web region protrudes over the other wall element increases the extent of the wall element.

It is even more advantageous if the web region also has a bend and thus the bend, especially if it runs transverse to the extent of the web region, enables additional stiffening transverse to the extent of the web region.

No further details have yet been provided regarding the connection of two abutting wall elements.

In principle, the wall elements can be connected using a conventional weld seam.

In order to influence the material properties as little as possible, it is preferably provided that a laser weld seam is used to connect two abutting walls.

The laser weld seam here can be a continuous or an interrupted weld seam.

Furthermore, another advantageous solution is that when two adjacent walls are connected, they form a plugged connection.

This type of plugged connection means that regions of the walls interlock.

In particular, to form the plugged connection, one of the walls is provided with a recess into which the other of the wall elements engages with a projection adapted to it.

In addition, it is preferable that the walls are welded together at least in the region of the plug-in connection, so that a permanently stable and, in particular, unbreakable connection of the wall elements is provided, even with changing force effects on the box-shaped structure.

No further details have been given regarding the course of the walls forming the box-shaped structure either.

For example, an advantageous solution provides that at least one of the walls has a course that deviates from a course in a plane, so that the impact body has a varying cross-section.

In particular, it is provided here that the wall facing away from the vehicle is curved in the direction away from the wall facing the vehicle, so that the box-shaped structure has a varying cross-section, at least with regard to the spacing between the wall facing the vehicle and the wall facing away from the vehicle.

No further details have yet been provided regarding the further configuration of the central unit.

For example, according to the invention, the central unit may only serve to connect the support elements to each other and to create a sufficient base for the impact energy absorption elements and the side impact elements.

However, a particularly favorable solution is that the central unit is formed in such a way that a trailer or load carrier attachment element is mountable on it and that the forces transmitted by the attachment element to the central unit are transmitted from the central unit to the support elements and from these to the side regions of the vehicle body.

In particular, the unit formed of central unit and the support elements is to be formed with such stability that the forces acting from the attachment element are safely transferred to the side regions of the vehicle body, regardless of how the crash behavior of the cross member is configured.

It is particularly favorable if the box-shaped structure of the central unit carries a receiving unit for the attachment element, i.e., this receiving unit for the attachment element is mountable on the box-shaped structure.

Furthermore, it is advantageously provided that the receiving unit for the attachment element is arranged in the central unit, i.e. in particular in the box-shaped structure.

Particularly in the case of the box-shaped structure being formed as a closed box-shaped structure, it is advantageous if the receiving unit for the attachment element is arranged in an interior space of the central unit, i.e., in particular in an interior space of the box-shaped structure.

The aforementioned solution is particularly advantageous if a wall of the central unit facing the roadway has an opening through which the attachment element with the receiving unit is insertable.

This means that the opening in the wall facing the roadway must be large enough to insert the receiving unit together with the mounted attachment element into the interior space of the central unit, i.e., in particular the box-shaped structure thereof.

This solution has the great advantage that the impact-absorbing cross member according to the invention can be used on vehicles that are delivered without an attachment element, and that the mounting element is subsequently insertable into the impact-absorbing cross member according to the invention in such vehicles in order to thus also fix the attachment element to the impact-absorbing cross member.

In this case, it is preferably provided for the attachment element in its working position to pass through the opening in the wall facing the roadway and thus reach under the cross member unit in the opposite direction to the direction of travel, so that the attachment element can extend to its coupling element in the opposite direction to the direction of travel.

The attachment element can be formed here in such a way that it is detachable from the receiving unit and thus stored separately in an unused position or rest position.

Another advantageous solution provides that the attachment element is arranged substantially in the interior space of the box-shaped structure of the central unit in a rest position.

Preferably, this solution can also be configured to receive a removable attachment element, for example.

However, it is particularly advantageous in this case if the attachment element is pivotable about at least one pivot axis between the working position and the rest position, so that the receiving unit comprises a pivot bearing unit for the attachment element, by means of which this is then pivotable about the pivot axis.

The above description of solutions according to the invention thus comprises in particular the various combinations of features defined by the following consecutively numbered embodiments:
1. An impact-absorbing cross member (20) which is mountable under a bumper unit (16) of a vehicle body (12) on a rear region (14) thereof, wherein the cross member (20) extends in a transverse direction (58) running parallel to the bumper unit (16) and has support elements (54, 56) arranged at the ends for support on side regions (64, 66) of the vehicle body (12), and wherein the support elements (54, 56) are connected to one another by a central unit (52) of the cross member (20), wherein side impact elements (172, 174) are provided on both sides of the central unit (52) so as to be movable relative thereto, said side impact elements being supported on the support elements (54, 56) of the cross member (20) by means of impact energy absorption elements (176, 178).
2. A cross member in accordance with embodiment 1, wherein the impact energy absorption elements (176, 178) have pre-formed wall elements (184) extending in a direction of extent (202) from the respective support element (54, 56) to the corresponding side impact element (172, 174), which wall elements are foldable for impact energy absorption.
3. A cross member in accordance with embodiment 2, wherein wall elements (184) of the impact energy absorption elements (176, 178) have a pre-stamping in such a way that these fold along pre-formed folds (186) for impact energy absorption, which folds extend transversely to the direction of extent (202) of the impact energy absorption elements (176, 178).
4. A cross member in accordance with the preceding embodiments, wherein the impact energy absorption elements (176, 178) are configured to at least partially surround a central axis parallel to the direction of extent (202).
5. A cross member in accordance with embodiment 4, wherein the impact energy absorption elements have a closed peripheral form around the central axis (182) parallel to the direction of extent (202).
6. A cross member in accordance with the preceding embodiments, wherein the impact energy absorption elements for supporting the side impact elements (172, 174) have an impact-side cross-sectional area (198) which is smaller than a support-side cross-sectional area (196) provided for the support on the support elements (54, 56).
7. A cross member in accordance with the preceding embodiments, wherein the impact energy absorption elements are configured to taper in their direction of extent (202) from the respective support element (54, 56) to the respective side impact element (172, 174).
8. A cross member in accordance with the preceding embodiments, wherein the side impact elements (172, 174), in a pre-impact position, are movably supported relative to the central unit (52).
9. A cross member in accordance with embodiment 8, wherein the side impact elements (172, 174) are movably supported for support on the central unit (52) by means of an articulated connection (217, 219), comprising in particular on the one hand an extension (212, 214) and on the other hand a receptacle (216, 218).
10. A cross member in accordance with embodiment 9, wherein the extensions (212, 214), in the pre-impact position, are secured in the receptacles (216, 218) against leaving the receptacles (216, 218).
11. A cross member in accordance with the preceding embodiments, wherein each of the side impact elements (172, 174) extends in the transverse direction (58) over at least one quarter of the total extent of the cross member (20) in the transverse direction (58).
12. A cross member in accordance with the preceding embodiments, wherein each of the side impact elements (172, 174) extends in the transverse direction (58) over a maximum of half the total extent of the cross member (20) in the transverse direction (58).
13. A cross member in accordance with the preceding embodiments, wherein each of the side impact elements (172, 174) is provided with beads (170) running in the transverse direction (58).
14. A cross member in accordance with the preceding embodiments, wherein the support elements (54, 56) have support surfaces (168) for the impact energy absorption elements (176, 178) which are at a spacing of less than 10 mm from body support surfaces (166) of the support elements (54, 56) by which these are supported on the side regions (64, 66) of the vehicle body (12).
15. A cross member in accordance with the preceding embodiments, wherein the support surfaces (168) for the impact energy absorption elements (176, 178) and the body support surfaces (166) of the support elements (54, 56) are arranged on opposite sides of the support elements (54, 56).
16. A cross member in accordance with embodiment 14 or 15, wherein the support surfaces (168) of the support elements for the impact energy absorption elements (176, 178) and the body support surfaces (166) of the support elements (54, 56) are arranged on opposite sides of a base plate (122) of the support elements (54, 56).
17. A cross member in accordance with the preceding embodiments, wherein the support elements (54, 56) have stabilizing elements (132, 134, 136, 138) outside the support surfaces (168) for the impact energy absorption elements (176, 178), which stabilizing elements improve the dimensional stability.
18. A cross member in accordance with embodiment 17, wherein the stabilizing elements (132, 134, 136, 138) have webs (132, 134, 136, 138) extending transversely to the support surface (168).
19. A cross member in accordance with embodiment 17 or 18, wherein the stabilizing elements (132, 134, 136, 138) are formed as wall portions extending transversely to the support surface (168).
20. A cross member in accordance with embodiments 17 to 19, wherein the stabilizing elements (132, 134, 136, 138) are formed in one piece on the base plate (122), in particular by bending.
21. A cross member in accordance with embodiments 18 to 20, wherein the webs (132, 134, 136, 138) extending transversely to the support surface (168) extend, starting from a side facing away from the central body (52), in the direction of the central unit (52) with increasing extent transversely to the support surface (168).
22. A cross member in accordance with embodiments 17 to 21, wherein the stabilizing elements (132, 134, 136, 138) extending transversely to the support surfaces (168) are formed integrally with the base plate (122) forming the support surface (168) and the body support surface (168).
23. A cross member in accordance with embodiment 22, wherein at least some of the stabilizing elements (134, 136, 138) are connected to each other.
24. A cross member in accordance with the preceding embodiments, wherein the central unit (52) comprises a box-shaped structure (70).
25. A cross member in accordance with embodiment 24, wherein some of the stabilizing elements (134, 136, 138) of the support elements (54, 56) are connected to walls (72, 74, 76, 78) of the box-shaped structure (70) of the central unit (52).
26. A cross member in accordance with embodiment 25, wherein the interconnected stabilizing elements (134, 136, 138) are connected to walls (72, 74, 76, 78) of the box-shaped structure (70).
27. A cross member in accordance with embodiments 24 to 26, wherein the box-shaped structure (70) of the central unit (52) has a wall (74) facing the vehicle and a wall (72) facing away from the vehicle, as viewed in the direction of travel.
28. A cross member in accordance with the embodiments 24 to 27, wherein the box-shaped structure (70) of the central unit (52) has a wall (78) facing away from the roadway.
29. A cross member in accordance with embodiments 24 to 28, wherein the box-shaped structure (70) of the central unit (52) has a wall (76) facing the roadway.
30. A cross member in accordance with the preceding embodiments, wherein the box-shaped structure (70) comprises at least one wall (72, 74, 76, 78) provided with at least one cut-out (312, 322, 324, 326, 332, 336).
31. A cross member in accordance with the preceding embodiments, wherein the at least one cut-out (312, 322, 324, 326, 332, 336) has an areal extent which corresponds in each direction to a maximum of 2 times, better still a maximum of 1.5 times, and even better still a maximum of 1 times the areal extent of a surface region (313, 325, 327, 332, 338) surrounding it in the respective direction.
32. A cross member in accordance with embodiment 30 or 31, wherein the at least one cut-out (312, 322, 324, 326, 332, 336) is surrounded on all sides by the surface region (313, 325, 327, 334, 338).
33. A cross member in accordance with embodiments 30 to 32, wherein the at least one cut-out (312, 322, 324, 326, 332, 336) has an outer contour with a substantially round and/or oval basic shape.
34. A cross member in accordance with embodiments 30 to 33, wherein the at least one cut-out (312, 322, 324, 326, 332, 336) has an edge region (354) which, in relation to the surface region (313, 325, 327, 334, 338) surrounding said cut-out, is raised relative to this surface region (352).
35. A cross member in accordance with embodiment 34, wherein the raised edge region (354) has a height transverse to the surface region (313, 325, 327, 332, 338) surrounding it which corresponds to at least twice the material thickness of the surface region (313, 325, 327, 332, 338) surrounding it.
36. A cross member in accordance with embodiments 24 to 35, wherein at least a part of the walls (72, 74, 76, 78) of the box-shaped structure (70) has an increased rigidity against deformation as a result of having been reshaped.
37. A cross member in accordance with embodiment 36, wherein at least one of the walls (72, 74, 76, 78) of the box-shaped structure (70) has a bending line (90) running parallel to the vertical longitudinal center plane (VL).
38. A cross member in accordance with embodiment 36 or 37, wherein at least one of the walls (72, 74, 76, 78) has at least one stamped bead (114, 362, 364, 366, 368).
39. A cross member in accordance with embodiment 38, wherein at least one of the walls (72, 74, 76, 78) has at least one stamped bead (114) which extends in the transverse direction (Q) to the vertical longitudinal center plane (VL).
40. A cross member in accordance with embodiment 38 or 39, wherein at least one of the walls (72, 74, 76, 78) has successively arranged stamped beads (362, 364, 366, 368) in the transverse direction (Q) of the box-shaped structure (70).
41. A cross member in accordance with embodiments 38 to 40, wherein the beads (362, 364, 366, 368) run inclined to the vertical longitudinal center plane (LV).
42. A cross member in accordance with embodiment 41, wherein successive beads (362, 364, 366, 368) run transversely to one another in the transverse direction (Q) to the vertical longitudinal center plane (VL).
43. A cross member in accordance with the preceding embodiments, wherein the central unit (52) is formed in such a way that an attachment element (40) for a trailer or a load carrier is mountable on it and that the forces transmitted by the attachment element (40) to the central unit (52) are transmitted from the central unit (52) to the support elements (54, 56) and from these to the side regions (64, 66) of the vehicle body (12).
44. A cross member in accordance with embodiment 43, wherein the box-shaped structure (70) of the central unit (52) carries a receiving unit (260, 260′) for the attachment element (40).
45. A cross member in accordance with embodiment 44, wherein the receiving unit (260, 260′) for the attachment element (40, 40′) is arranged in the central unit (52).
46. A cross member in accordance with embodiments 43 to 45, wherein the receiving unit (260, 260′) for the attachment element (40 40′) is arranged in an interior space (82) of the central unit (52).
47. A cross member in accordance with embodiment 46, wherein a wall (76) of the central unit (52) facing the roadway has an opening (84), through which the attachment element (40, 40′) with the receiving unit (260, 260′) is insertable.
48. A cross member in accordance with embodiments 43 to 47, wherein the attachment element (40, 40′) in its working position (A) extends through the opening (84).
49. A cross member in accordance with embodiments 43 to 48, wherein the attachment element (40, 40′) is arranged substantially in the interior space (82) of the box-shaped structure (70) of the central unit (52) in a rest position (R).

Further features and advantages of the invention are the subject of the following description as well as the illustration of some exemplary embodiments in the drawings.

### BRIEF DESCRIPTION OF THE DRAWINGS

FIG. 1 shows a side view of a motor vehicle with a bumper unit arranged on a rear region of the vehicle body and an impact-absorbing cross member covered by the bumper unit, which cross member in this case is part of an attachment coupling, so that an attachment element is held on the impact-absorbing cross member;

FIG. 2 shows a sectional view of the rear region of the motor vehicle body with an impact-absorbing cross member mounted on the rear region, said cross member being supported by means of side regions of the rear region;

FIG. 3 shows a perspective view of a unit formed of the central unit and the support elements held by it, but without side impact elements and impact energy absorption elements, as part of a first exemplary embodiment;

FIG. 4 shows a plan view from behind of the unit formed of central unit and support elements in accordance with FIG. 3, likewise without impact energy absorption elements and side impact elements;

FIG. 5 shows a section along line 5-5 in FIG. 4;

FIG. 6 shows a section along line 6-6 in FIG. 4;

FIG. 7 shows a section along line 7-7 in FIG. 4;

FIG. 8 shows a perspective view of the impact-absorbing cross member comprising the central unit and the support elements as well as the impact energy absorption elements and the side impact elements in accordance with the first exemplary embodiment;

FIG. 9 shows a plan view from behind of the impact-absorbing cross member in accordance with the first exemplary embodiment;

FIG. 10 shows a perspective view of a unit formed of impact energy absorption element and side impact element arranged on the left side of the impact-absorbing cross member;

FIG. 11 shows a perspective view of a unit formed of impact energy absorption element and side impact element arranged on the right-hand side on the impact-absorbing cross member;

FIG. 12 shows a section along line 12-12 in FIG. 9;

FIG. 13 shows a section similar to FIG. 6 through the first exemplary embodiment in the right-hand region of the cross member and the articulated connection of the side impact element to the central unit;

FIG. 14 shows a detail view of a wall of the central unit facing away from the vehicle with side impact elements movably supported thereon;

FIG. 15 shows a section similar to FIG. 13 of a variant of the articulated connection of a side impact element to the central unit;

FIG. 16 shows a view similar to FIG. 14 of the variant of the articulated connection between the central unit and the side impact elements;

FIG. 17 shows a schematic exemplary illustration of a side impact on the right-hand side of the impact-absorbing cross member;

FIG. 18 shows an illustration of a unit formed of attachment element and receiving unit, in this case formed as a pivot bearing unit with an attachment element, drawn by a solid line, in the working position and an attachment element, indicated by a dashed line, in the rest position;

FIG. 19 shows a section similar to FIG. 6 through the central unit according to the invention with the receiving unit mounted in an interior thereof together with the attachment element;

FIG. 20 shows a perspective view of the crash-absorbing cross member with mounted receiving unit and an attachment element in the working position;

FIG. 21 shows a view similar to FIG. 19 with an attachment element in the rest position;

FIG. 22 shows a perspective view similar to FIG. 20 with the attachment element in the rest position;

FIG. 23 shows an illustration similar to FIG. 19 with a variant of a receiving unit for receiving a detachably mountable attachment element;

FIG. 24 shows a perspective view similar to FIG. 20 with the detachably mountable attachment element in the working position;

FIG. 25 shows a perspective view of the unit formed of the central unit and the support elements held by these in accordance with FIG. 3, looking from below in the direction of the motor vehicle as part of a second exemplary embodiment;

FIG. 26 shows a perspective view of the unit in accordance with FIG. 25 of the second exemplary embodiment, looking away from the motor vehicle from above;

FIG. 27 shows a perspective view of the unit similar to FIG. 25 of a third exemplary embodiment;

FIG. 28 shows a perspective view of the unit similar to FIG. 26 of the third exemplary embodiment;

FIG. 29 shows a section along line 29-29 in FIG. 27; and

FIG. 30 shows a view similar to FIG. 3 of a fourth exemplary embodiment.

### DETAILED DESCRIPTION OF THE INVENTION

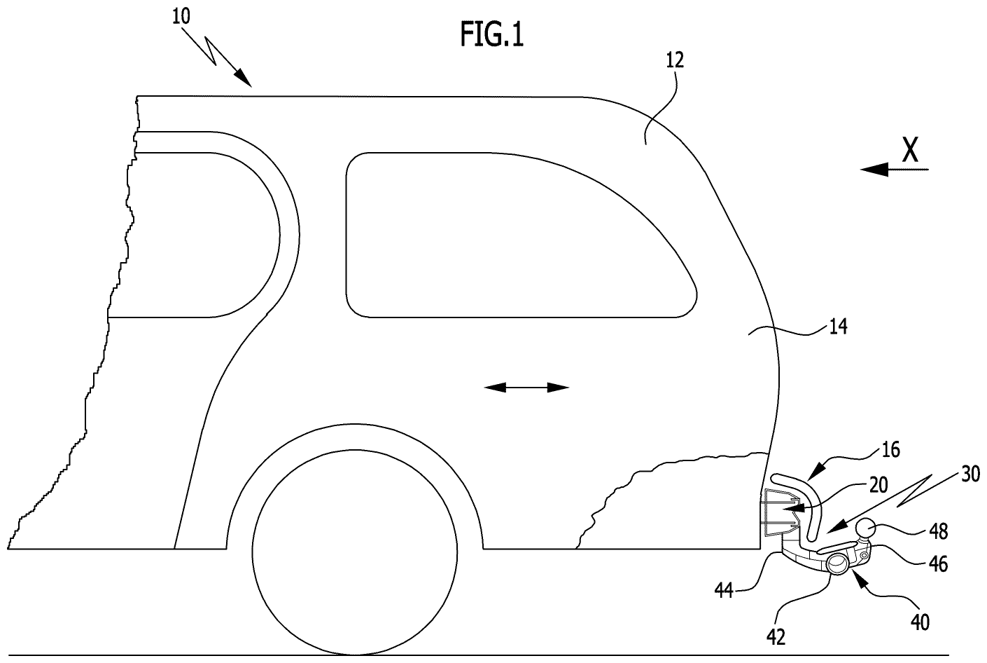

The invention is for use on a motor vehicle 10, which has a vehicle body 12 which carries a bumper unit designated as a whole by 16 on a vehicle rear 14, as shown in FIG. 1.

Concealed by the bumper unit 16, an impact-absorbing cross member designated as a whole by 20 is arranged on the vehicle rear 14 and can be part of an attachment coupling designated as a whole by 30 or can be extended to form an attachment coupling designated as a whole by 30, if, in addition, an attachment element 40, in particular in the form of a ball neck 42, is provided on the impact-absorbing cross member 20 and extends from a first end 44, which is connected to the impact-absorbing cross member 20, to a second end 46, which carries a coupling element 48, for example in the form of a coupling ball.

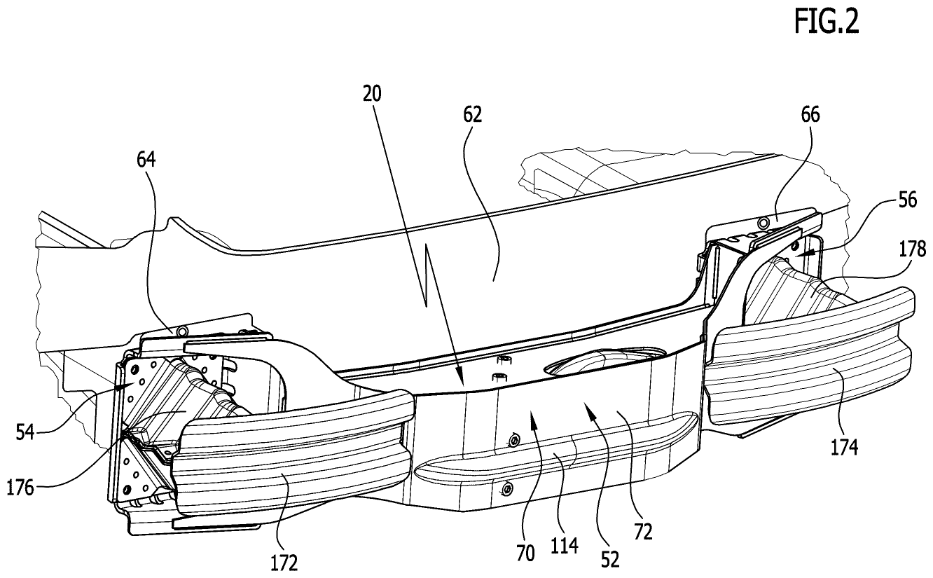

The impact-absorbing cross member 20 shown in FIG. 2 in conjunction with a detail of the vehicle rear 14 comprises a central unit 52, which is provided with support elements 54, 56 in a transverse direction 58 running parallel to the bumper unit 16, which are fixedly connected to the central unit 52.

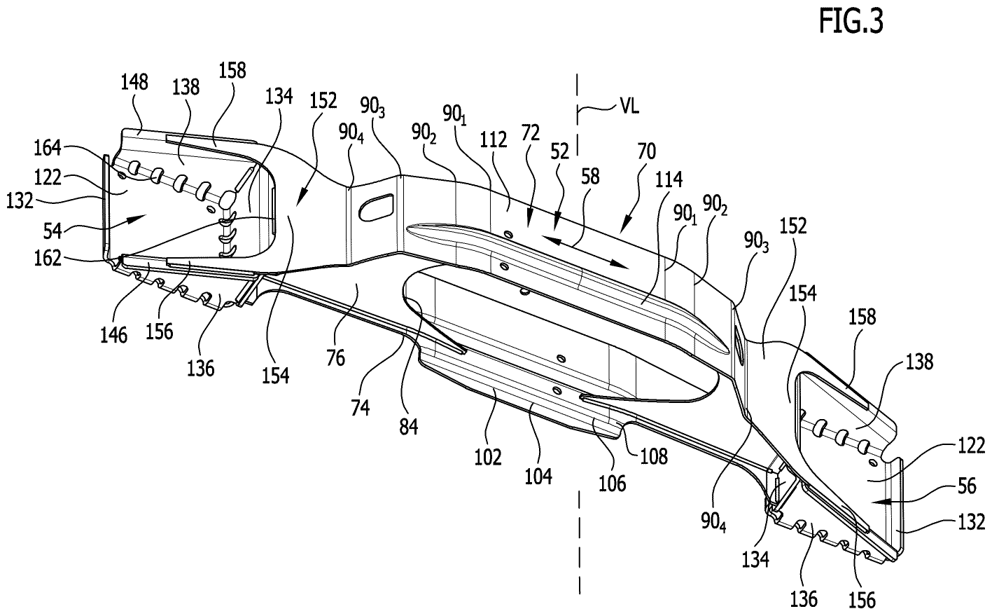

The support elements 54, 56, for example shown in FIGS. 2 and 3, are supported on side regions 64, 66 of the rear region 14, which are usually configured so that they can absorb the forces occurring in a crash and transfer them to the rear region 14, whereas a central portion 62 of the rear region 14 located between the support regions 64, 66 is not suitable for absorbing forces in the event of a crash.

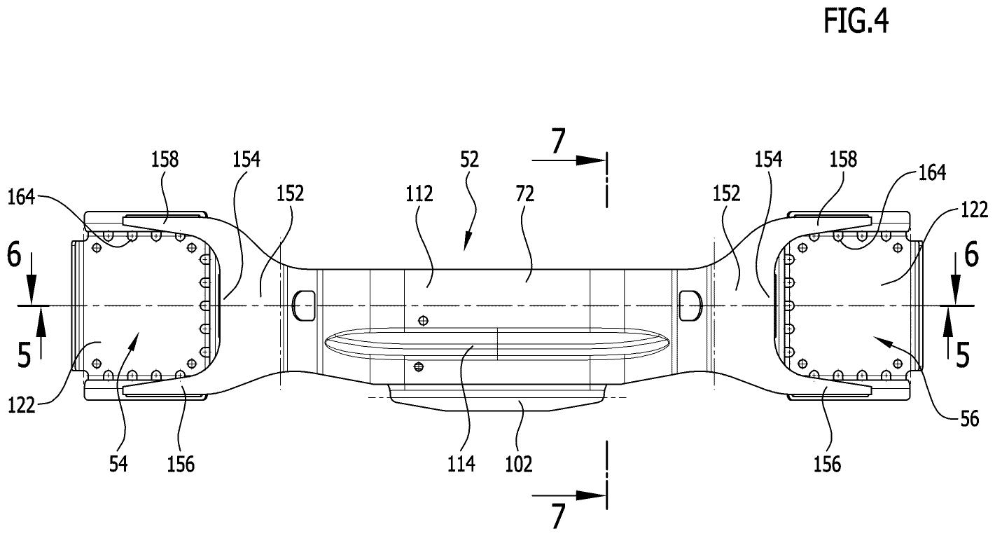

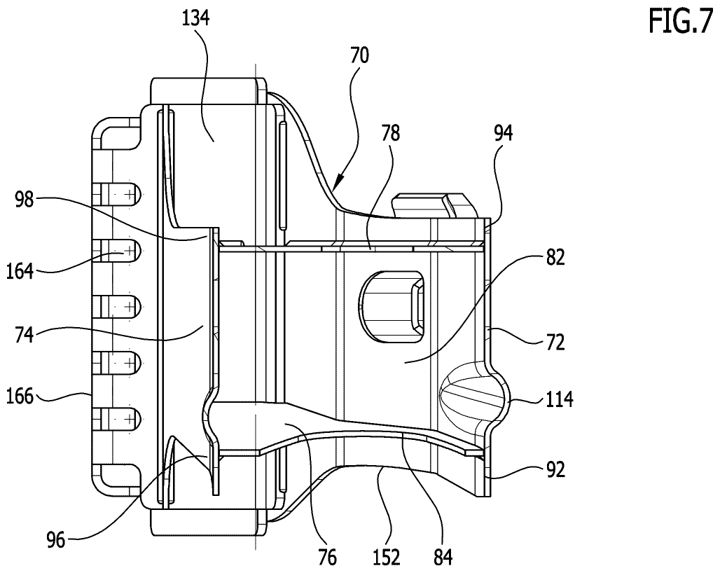

As shown in FIGS. 3 to 7, the central unit 52 comprises a box-shaped structure 70, which has a wall 72 facing away from the vehicle, a wall 74 facing the vehicle, a wall 76 facing the roadway and a wall 78 facing away from the roadway, which, as shown in FIG. 7, enclose an interior space 82 of the central unit 52.

For example, the interior space 82 is accessible from the roadway by means of a roadway-side opening 84 in the wall 76 facing the roadway.

In addition, the wall 78 facing away from the roadway is preferably also provided with an opening 86, which, however, has a smaller cross-section than the opening 84 and is located above a side of the interior space 82 facing the support element 56.

For stiffening the wall 72 facing away from the vehicle, it is preferably provided that this has, for example, bends 901, 902, 903 and 904 arranged symmetrically with respect to a vertical longitudinal center plane VL and running approximately parallel to this vertical longitudinal center plane VL, wherein the bends 901, 902, 903, 904 extend at a maximum angle of 15° relative to the vertical longitudinal center plane VL, preferably are oriented parallel, and also run parallel to one another, and the bends 901, 902, 903 and 904 run at a distance from one another and in each case at an increasing spacing from the vertical longitudinal center plane VL.

This not only improves the rigidity of the wall 72 facing away from the vehicle, but also of the entire box-shaped structure 70.

Preferably, the wall 72 facing away from the vehicle, the wall 74 facing the vehicle, the wall 76 facing the roadway and the wall 78 facing away from the roadway are welded together as shown in FIG. 7, wherein the wall 72 facing away from the roadway extends with end wall portions 92, 94 beyond the wall 76 facing the roadway and the wall 78 facing away from the roadway, and the wall 74 facing the vehicle likewise extends with its end wall portions 96, 98 beyond the wall 76 facing the roadway and the wall 78 facing away from the roadway.

The rigidity of the central unit 52 can be further improved by these wall portions 92, 94, 96, 98.

Furthermore, to improve the rigidity of the central unit 52 due to the size of the opening 84 in the wall 76 facing the roadway, the wall 74 facing the vehicle is also provided with an additional stiffening wall portion 102, which in the region of the opening 84 additionally extends in the direction of the roadway beyond the wall 76 facing the roadway and preferably, as shown in FIG. 3, also has bends 104, 106 and 108 running parallel to the wall 76 facing the roadway, which also improve the rigidity of the wall 74 facing the vehicle in the region of the opening 84 in the wall 76 facing the roadway (FIG. 3).

In addition, as shown in FIG. 7, the wall 72 facing away from the vehicle is provided with a bead 114 substantially over a central portion 112 of the wall 72 facing away from the vehicle, which bead also improves the rigidity of the central portion 112, preferably also in the region of the opening 84.

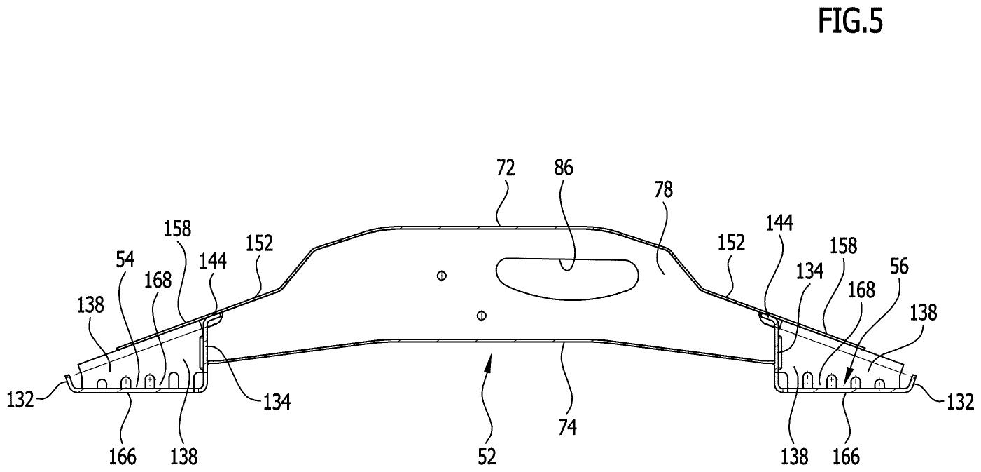

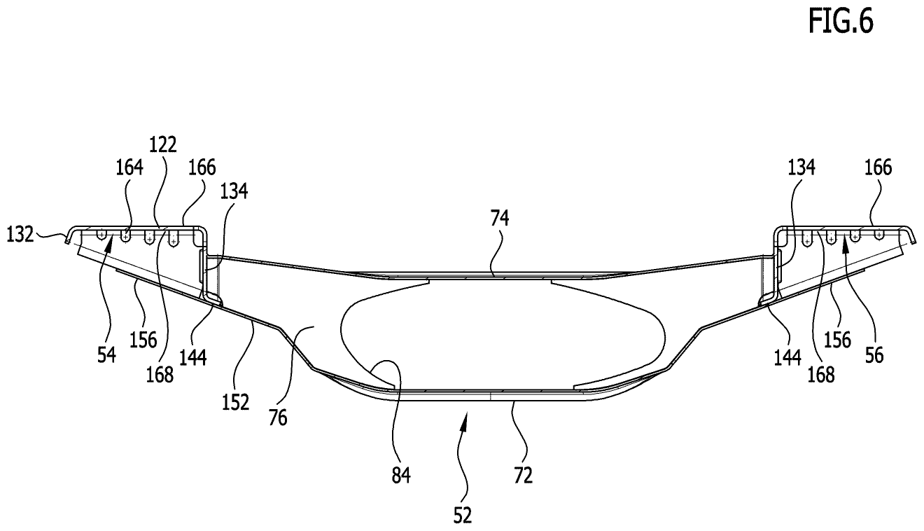

As shown in FIGS. 5 and 6, each of the support elements 54, 56 comprises a base plate 122, which is provided peripherally with webs surrounding the base plate 122 and integrally molded on the base plate 122 by bending and extending transversely thereto away from the side regions 64, 66 as wall portions, wherein a wall portion 132 facing away from the central unit 52 has the smallest extent transversely to the base plate 122, whereas a wall portion 134 facing the central unit 52, which wall portion is also integrally connected to the base plate 122, has the greatest extent starting from the base plate 122 in the direction away from the side regions 64 and 66, wherein this wall portion 134 forms an end-side termination of the box-shaped structure 70.

Furthermore, a wall portion 136 facing the roadway and a wall portion 138 facing away from the roadway are formed on the base plate 122 and extend, starting from the wall region 132, away from the base plate 122 in the direction of the wall portion 134 with increasing extent and are welded to the wall portion 134 on their sides adjacent thereto.

Furthermore, the wall region 134 facing the central unit 52 is also provided with a bend 144 on its side facing away from the base plate 122, which bend is fixedly welded to an end region 154 of the lateral branch 152 of the wall 72 facing away from the vehicle and, in addition, the wall portion 136 facing the roadway and the wall portion 138 facing away from the roadway are also provided with bends 146 and 148, which are welded to fork-shaped extensions 156 and 158 of the end region 154 of the lateral branch 152 of the central unit 52 abutting said bends, so that the lateral branch 152 encloses a recess 162 extending from the central unit 52 like a fork between the end region 154 of the lateral branch 152 and the extensions 156 and 158 of the lateral branch 152, wherein the extent of the recess 162 corresponds substantially to the extent of the base plate 122.

For additional stiffening between the base plate 122 with the wall portions 134, 136 and 138, shapings 164 are formed into the bending edge representing a transition between said wall portions and further stiffen the orientation of the wall portions 134, 136 and 138 relative to the base plate 122.

Thus, each of the support elements 54 and 56 forms with the wall portions 132, 134, 136, 138 extending away from the side regions 64 and 66 of the rear region 14 a rigid structure similar in itself to a pot, which is fixedly connected by the wall portions 134, 136 and 138 on the one hand to the wall 72 facing away from the vehicle by virtue of its branch 152 and, in particular, is fixedly connected by the wall portion 134, as shown in FIGS. 5 to 7, both to the wall 74 facing the vehicle and to the wall 76 facing the roadway and the wall 78 facing away from the roadway by welding.

Overall, the central unit 52 with the support elements 54 and 56 forms an inherently rigid and stable structure, which abuts in each case with a body support surface 166 of the respective base plate 122 against a respective one of the side regions 64, 66 of the rear region 14 and also has a support surface 168, which is opposite the body support surface 166 and which serves to absorb the forces in the event of a side impact.

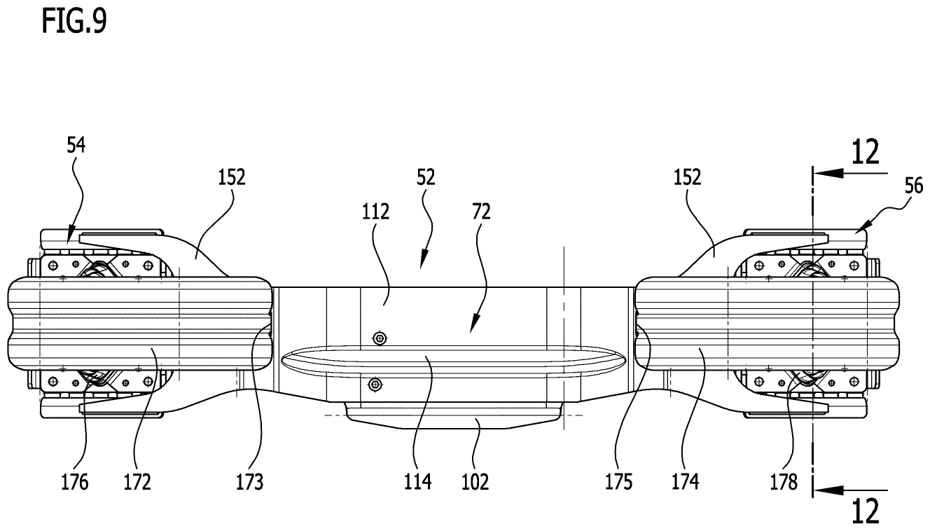

For this purpose, as shown in FIG. 2 and FIGS. 8 to 13, the cross member 20 comprises side impact elements 172 and 174, which are arranged opposite the support elements 54 and 56 on both sides of the central unit 52 and which are supported on the support elements 54 and 56 by means of impact energy absorption elements 176 and 178.

Each of the side impact elements 172 and 174 preferably extends in the transverse direction 58 over at least one quarter and less than one third of the total extent of the cross member 20 in the transverse direction 58.

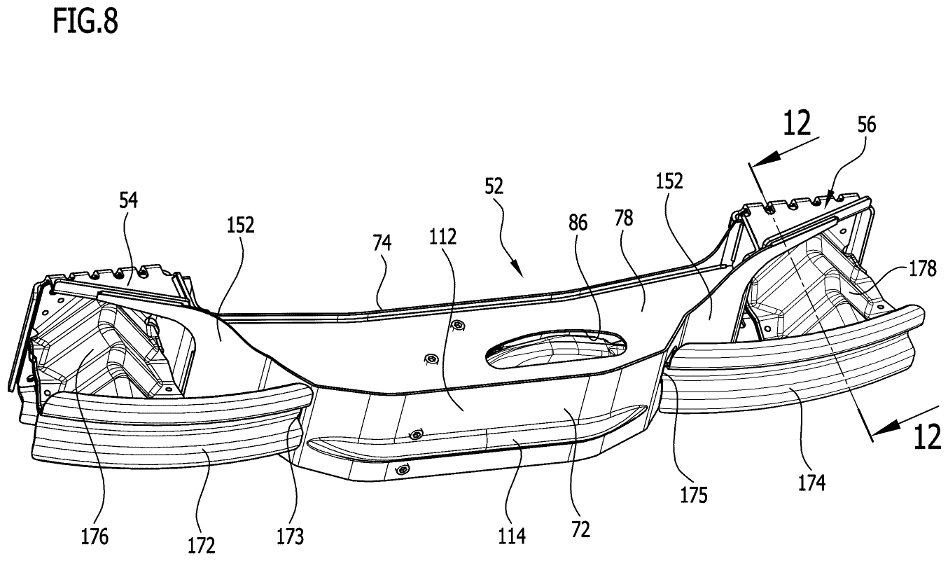

The side impact elements 172 and 174 extend here, as shown for example in FIG. 8, approximately in the transverse direction 58 laterally in continuation of the central portion 112 of the wall 72 facing away from the vehicle at approximately the same spacing from the vehicle rear 14 as the central portion 112 and, in particular, overlap the branches 152 of the wall 72 facing away from the vehicle lying to the side of the central portion 112, so that a sufficiently large gap is available between these and the side impact elements 172 and 174 in the direction of travel in the event of an impact, as can be seen from FIG. 8.

In particular, the side impact elements 172 and 174 are provided with beads 170 running parallel to their extent in the transverse direction 58 in order to increase stability.

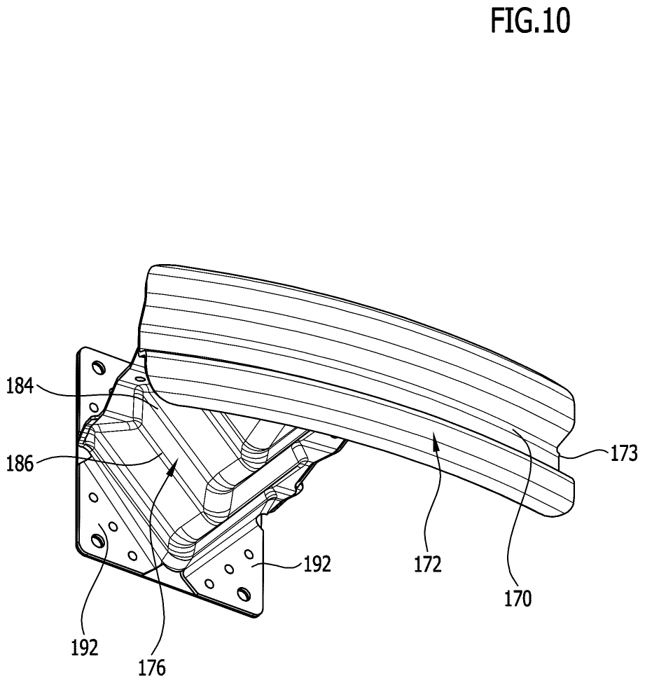

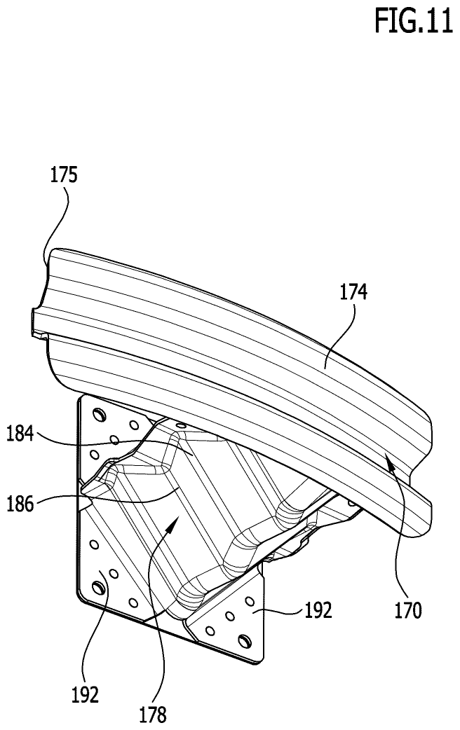

The impact energy absorption elements 176 and 178 shown in FIGS. 10 and 11 are formed, for example, as hollow bodies 180 surrounding a central axis 182, the wall elements 184 of which have folds 186 already pre-formed transversely to the central axis 182, wherein the folds 186 of the wall elements 184 predefine the forming deformations of the impact energy absorption elements 176 and 178 in the event of an impact on the respective side impact element 172, 174.

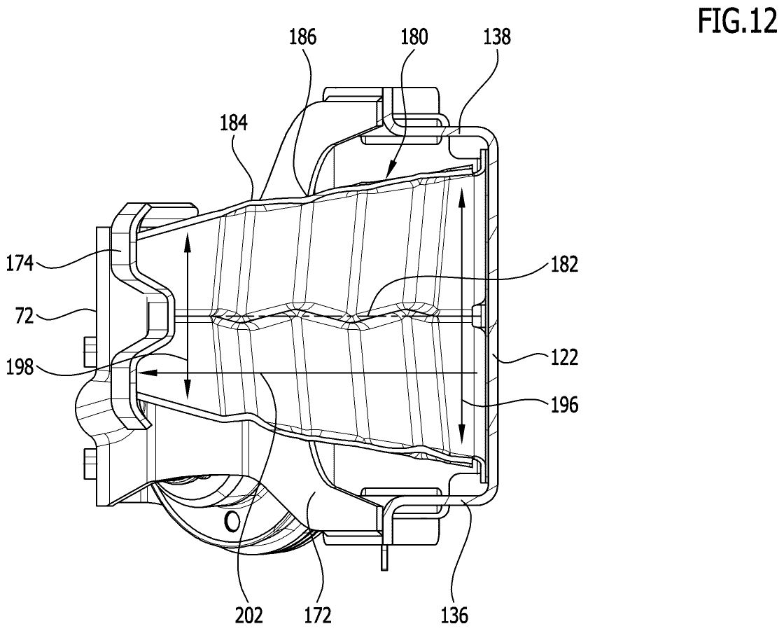

Furthermore, the impact energy absorption elements 176 and 178 each have support flanges 192 resting on the corresponding base plate 122, which support flanges abut the respective support surface 168 in a planar manner, wherein the impact energy absorption elements 176 and 178 have a cross-sectional extent 196 in the region of the support surface 168, which is greater than a cross-sectional extent 198 in the region of the side impact elements 174 and 176 (FIG. 12).

The different cross-sectional extents 196 and 198 contribute to the impact energy absorption elements 176 and 178 deforming approximately parallel to their central axis 182 in the event of a crash, shortening their dimension in their direction of extent 202 between the base plate 122 and the respective side impact element 172, 174 and thus being able to absorb the maximum crash energy.

As shown in FIGS. 7, 8, 11, 13 and 14, the side impact elements 172 and 174 are not only supported by means of the impact energy absorption elements 176 and 178 on the support elements 54 and 56 of the cross member 20, but also on the central unit 52, namely by means of extensions 212, 214 extending starting from the end regions 173, 175 of the side impact elements 172, 174 facing the central portion 112 in the direction of the central portion 112, which extensions engage in receptacles 216 and 218, provided for them, which are provided in the wall 72 facing away from the vehicle, and in particular in a transition region 222, which is arranged in each case between the central portion 112 and the branches 152 of the wall 72 facing away from the vehicle and extends obliquely from the central portion 112 in the direction of the branches 152.

Thus, at least in a pre-impact position of the side impact elements 172, 174, there is an articulated connection 217, 219 of said side impact elements to the central unit 52.

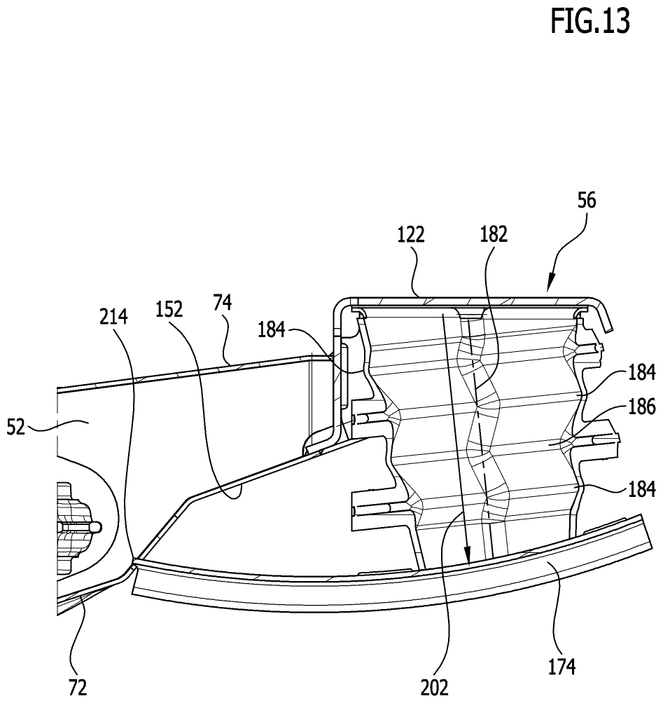

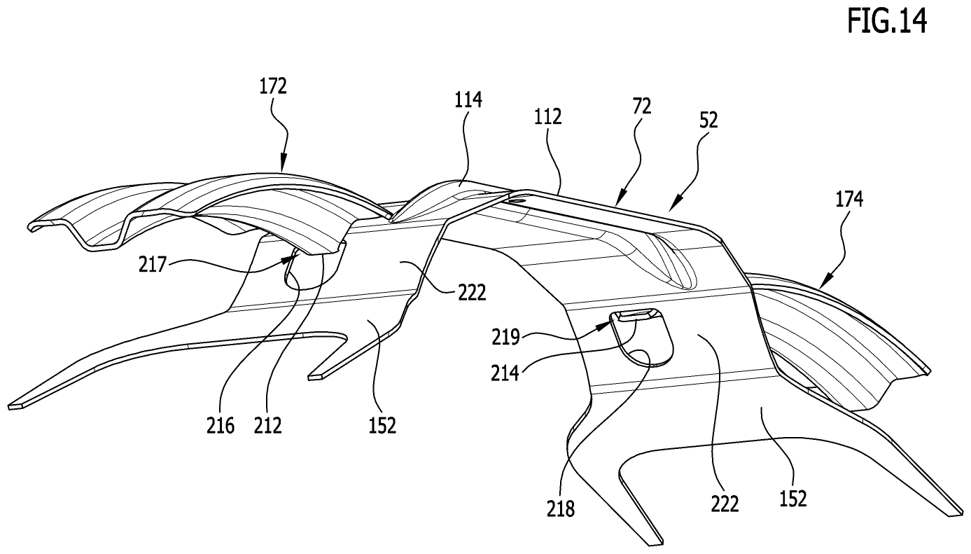

The extensions 212 and 214 thus provide additional support and guidance of the side impact elements 172 and 174 relative to the central unit 52 in the event of a crash, i.e., when one of said side impact elements is struck, in order to achieve the most uniform possible deformation of the respective impact energy absorption element 176 or 178 and thus optimum absorption of the impact energy (FIG. 13 and FIG. 14).

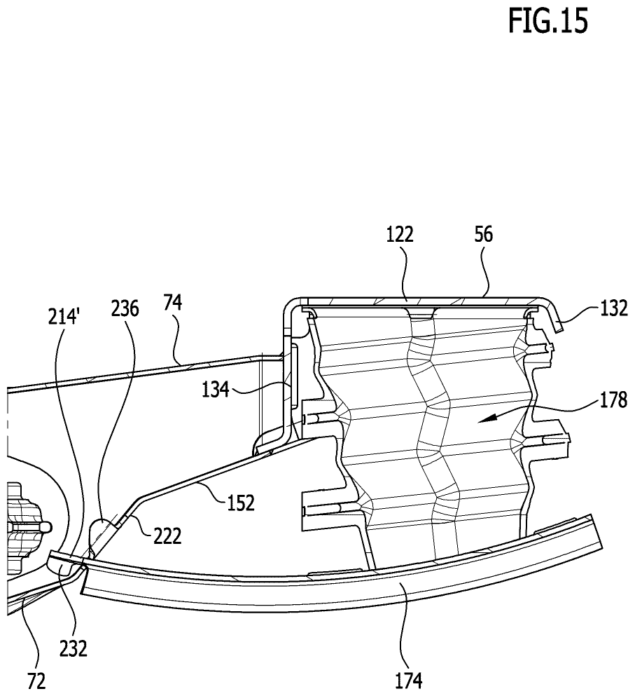

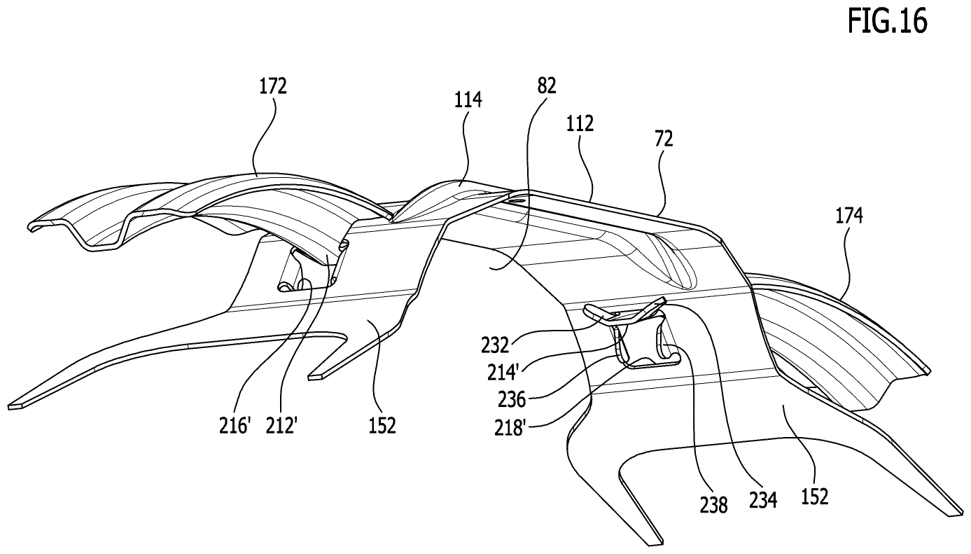

In a variant of the solution described above shown in FIG. 15, the extensions 212′ and 214′ are provided with projections 232 and 234 extending laterally thereof, which prevent the extensions 212′ and 214′ from sliding out of the receptacles 216′ and 218′, wherein the receptacles 216′ and 218′ are additionally provided with guide cheeks 236, 238 projecting into the interior space 82 of the central unit 52, which ensure that the extensions 212′ and 214′ with the lateral projections 232, 234 are held in a defined position relative to the receptacles 216′, 218′.

This solution thus permits more precise pivotable guidance of the side impact elements 172 and 174 relative to the central unit 52.

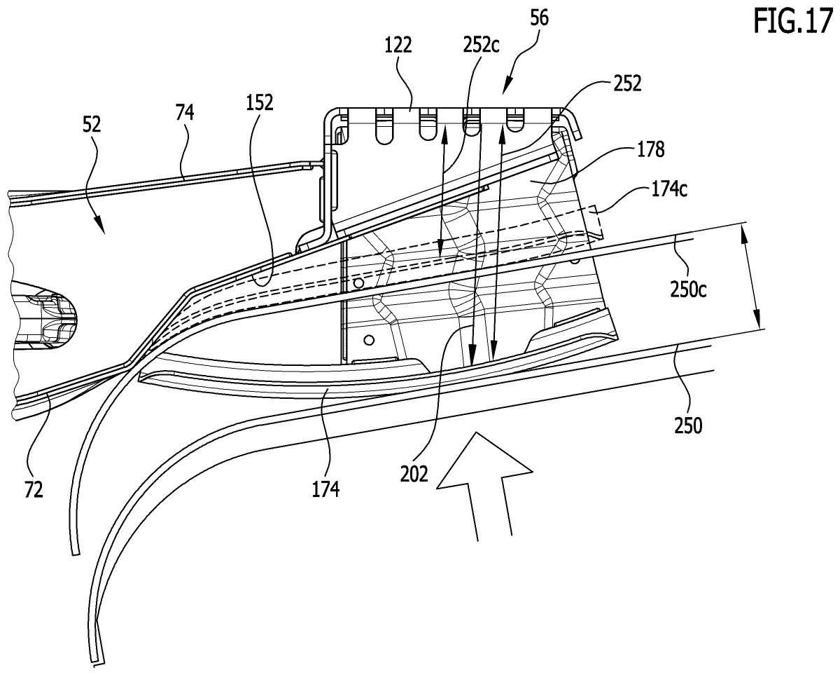

As shown in FIG. 17, the construction of the side impact elements 172 and 174 and the impact energy absorption elements 176 and 178 in accordance with the invention, as illustrated by the example of the side impact element 174 and the impact energy absorption element 178, results in the fact that a bumper 250 of a colliding vehicle impacting on the side impact element 174, which is in a pre-impact position, deforms the side impact element 174 on the one hand and moves it, at least initially still guided by the extension 214 and the receptacle 218, with a pivoting movement about the latter in the direction of the support element 56 and at the same time deforms the impact energy absorption element 178 in such a way, that its extent 252 in the direction of extent 202 in the pre-impact position is reduced to a direction of extent 252c which is approximately half of the extent 252.

Thus, there is still a sufficiently large extent 252c of the deformed impact energy absorption element 178 starting from the base plate 122, so that the impact energy absorption element 178 is deformed starting from its original extent 252 in the direction of extent 202 and is reduced by activation of the folding of said impact energy absorption element in such a way that, during the deformation up to the shortened extent 252c in the direction of extent 202, a defined deformation thus definably determining the energy absorption takes place and is capable of absorbing the required impact energy in the event of an RCAR crash requirement and transferring it to the respective side region 66 of the rear region 16.

Furthermore, the branch 152 of the wall 72 of the central unit 52 facing away from the vehicle is preferably arranged relative to the support elements 54 and 56, in FIG. 17 the support element 56, such that even the deformed side impact element 174c does not lead to any deformation in the region of the branch 152 of the wall 72 of the central unit 52 facing away from the vehicle.

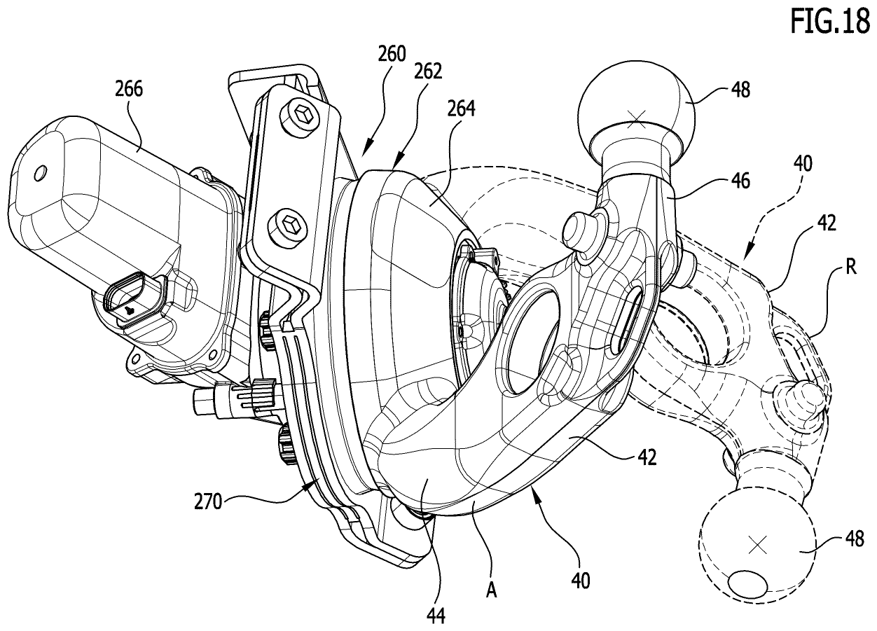

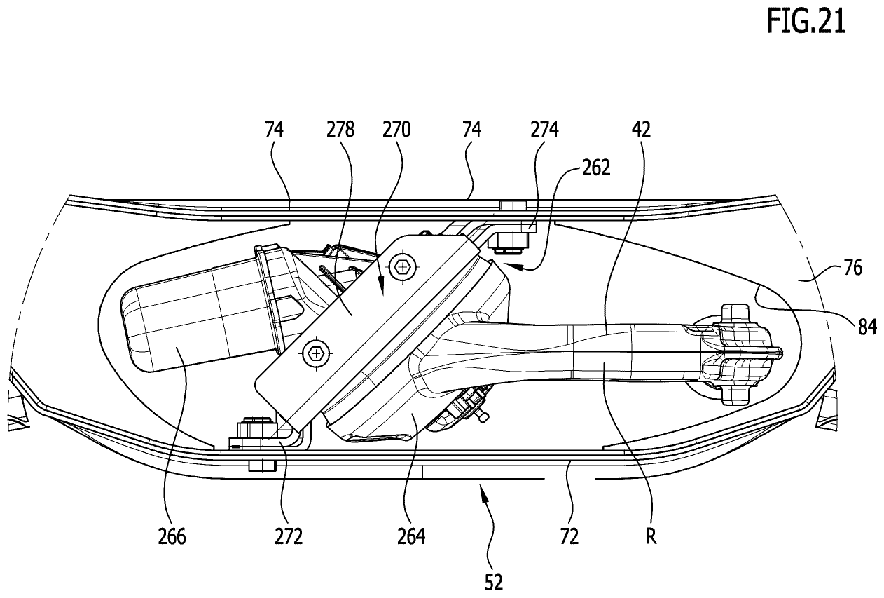

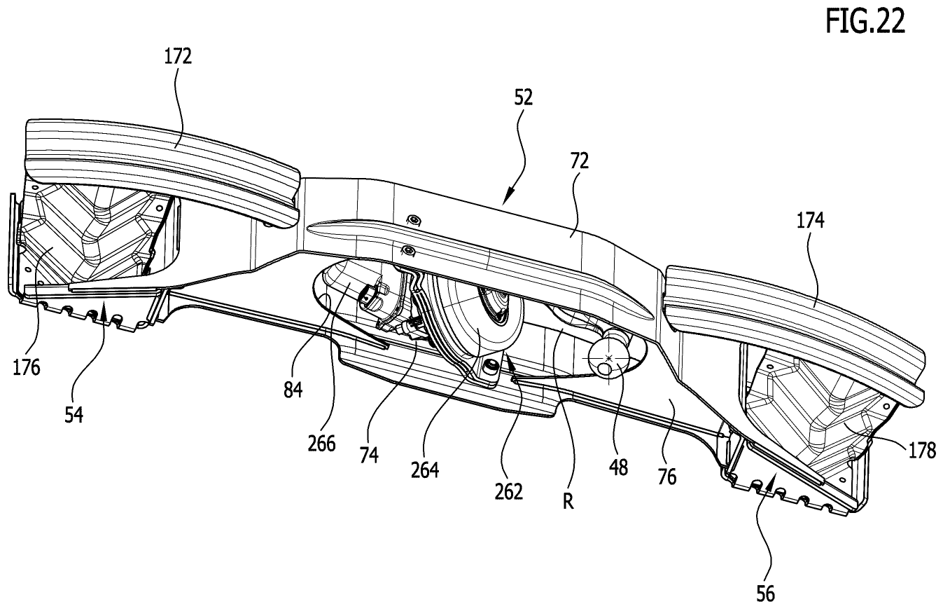

In order to extend the impact-absorbing cross member 20 to form an attachment coupling 30 which comprises the attachment element 40, the attachment element 40 is provided, as shown in FIG. 18, with a receiving unit, designated as a whole by 260, for the attachment element 40, which in the exemplary embodiment shown in FIG. 18 comprises on the one hand a pivot bearing unit 262, which has a pivot bearing body 264, with which the attachment element 40 is connected to the first end 44, so that by rotating the pivot bearing body 264 about, for example, a pivot axis S running obliquely to a longitudinal center plane L of the motor vehicle, the attachment element 40 is pivotable from a working position shown in FIGS. 18, 19 and 20, which is drawn by a solid line in FIG. 18, into a rest position R, which is indicated by a dashed line in FIGS. 18, 21 and 22 and shown in FIGS. 21 and 22, in which, for example, the ball neck 42 extends starting from the pivot bearing body 264 such that the coupling element 48 lies below the ball neck 42 in the direction of gravity.

The pivot bearing unit 262 is drivable here by a drive motor 266, for example.

For mounting the pivot bearing unit 262 in the interior space 82 of the box-shaped structure 70, the latter is held on a mounting base designated as a whole by 270, wherein the pivot bearing unit 262 passes through the mounting base 270, for example in the form of a flange unit, and wherein for example the drive motor 266 is arranged on one side of the mounting base 270 and the pivot bearing body 264 is located on the opposite side.

In particular, in the solution according to the invention, the entire receiving unit 260 together with the mounted attachment element 40 and the mounting base 270 is insertable through the opening 84 in the wall 76 facing the roadway, shown in FIGS. 2, 20 and 22, into the interior space 82 of the box-shaped structure 70 of the central unit 52, wherein the mounting base 270 has a mounting flange 272 for connection to the wall 72 facing away from the vehicle, a mounting flange 274 for connection to the wall 74 of the central unit 52 facing the vehicle and a mounting flange 278 for connection to the wall 78 of the central unit 52 facing away from the roadway, so that a stable connection between the pivot bearing unit 262 and the central unit can be produced by means of the mounting base 270.

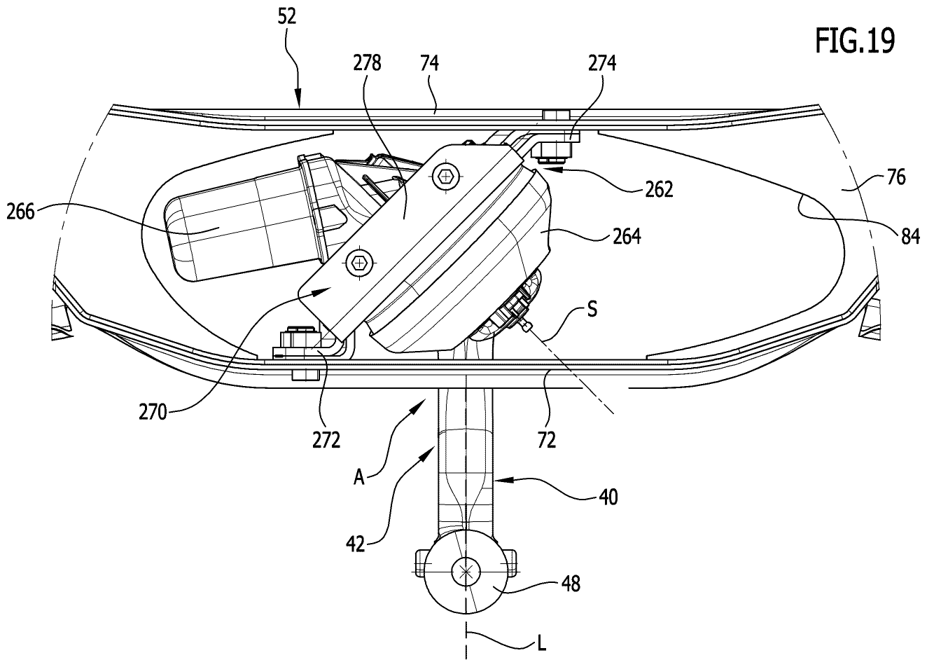

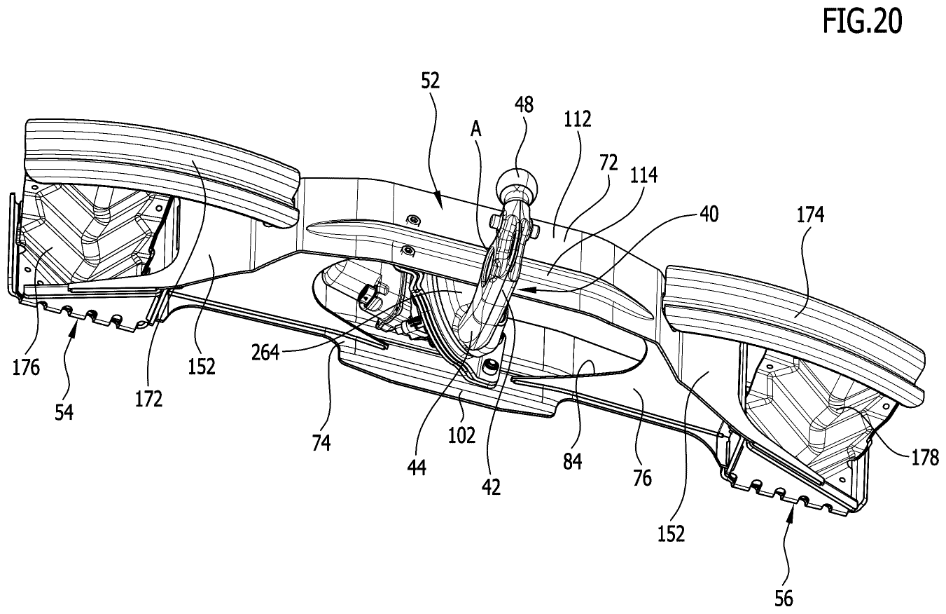

The installed position of the mounting base 270 in the central unit 52 is selected here in such a way that, as shown in FIG. 19 and FIG. 20, the attachment element 40 then, when it is in the working position A, extends starting from the pivot bearing body 264 with the first end 44 downwards through the opening 84 in the wall of the ball neck 42 facing the roadway, extends under the wall 72 facing away from the vehicle in the opposite direction to the direction of travel, so that the coupling element 48 in the working position lies behind the wall 72 facing away from the vehicle in the opposite direction to the direction of travel, as shown in FIGS. 19 and 20.

However, if the attachment element 40 is pivoted from the working position A into the rest position R, the ball neck 42 together with the coupling element 48 moves under the wall 72 facing away from the vehicle and from below through the opening 84 into the interior space 82 of the central unit 52, wherein in this case the ball neck 42, starting from the pivot bearing body 264, extends between the wall 72 facing away from the vehicle and the wall 74 facing the vehicle and lies close to the wall 78 facing away from the vehicle.

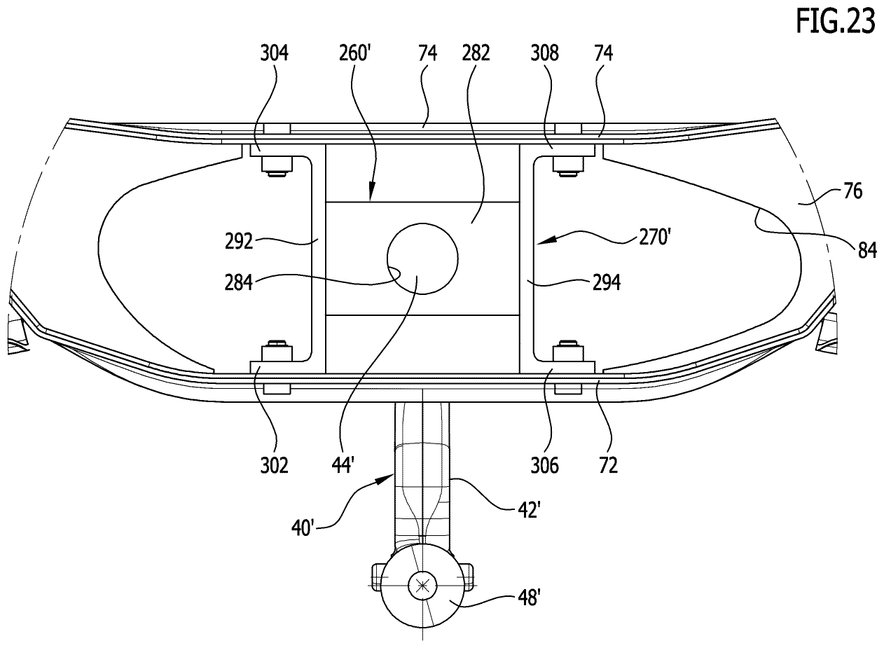

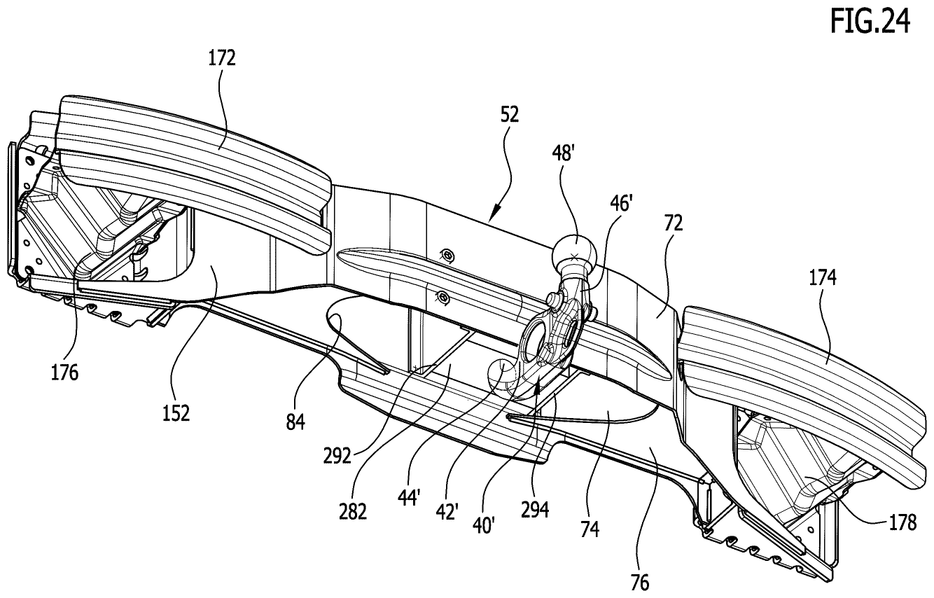

As an alternative to the receiving unit 260 for a pivotable attachment element 40, a further exemplary embodiment, shown in FIGS. 23 and 24 provides a receiving unit 260′ which has a bearing block 282 which is provided with a receptacle 284 into which a first end 44′ of the attachment element 40′ is configured to be plugged and is lockable by a locking device, not shown, so that the entire attachment element 40′ with the first end 44′, the ball neck 42′ and the coupling element 48′ is removable from the bearing block 282 by removing the first end 44′ downwards and is configured to be stored separately in the motor vehicle.

For its part, the bearing block 282 is still mountable on the wall 72 facing away from the vehicle and the wall 74 facing the vehicle by means of a mounting base 270′, for example in that the mounting base 270′ has two flange plates 292 and 294, which receive the bearing block 282 between them, are fixedly connected to the bearing block 282 and are in turn connected to the wall 72 facing away from the vehicle and the wall 74 facing the vehicle by means of mounting flanges 302, 304, 306 and 308, in order to be able to mount the entire receiving unit 260′ in the interior space 82 of the central unit 52 as well, if required, and thus to use the impact-absorbing cross member 20 as part of the attachment coupling 30

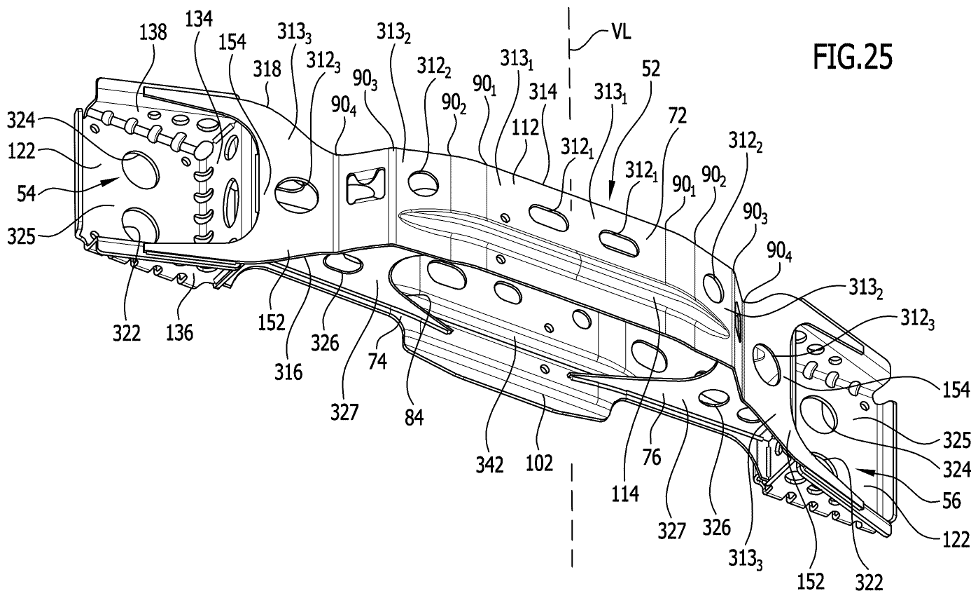

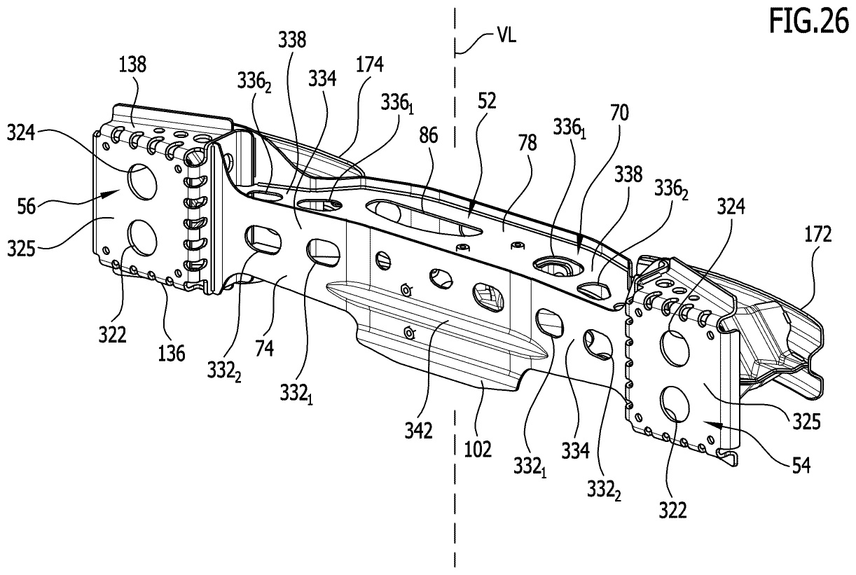

In a second exemplary embodiment, in which, according to FIGS. 25 and 26, only the central unit 52 and the support elements 54 and 56 held by it are shown, in order to achieve an additional weight saving, the central unit 52 in the region of the wall 72 facing away from the vehicle on both sides of the vertical longitudinal center plane VL, which in particular coincides with the vertical longitudinal center plane of the motor vehicle, is provided with cut-outs 3121, 3122, 3123 arranged symmetrically with respect to the vertical longitudinal center plane VL, which are each arranged at a spacing from the vertical longitudinal center plane VL.

For example, the cut-outs 3121 are each surrounded by a surface region 3131 of the wall 72 facing away from the vehicle, which lies between the vertical longitudinal center plane VL and the bends 901; the cut-outs 3122 lie between the bends 902 and 903 surrounded by surface regions 3132; and the cut-outs 3123 lie in each case in the lateral branches 152 surrounded by surface regions 3133.

The cut-outs 3121, 3122, 3123 are selected such that their extent in all directions, in particular in the direction parallel and transverse to the vertical longitudinal center plane VL, is at most twice that of the respective surface region 3131, 3132, 3133 surrounding them in the respective direction, within which these cut-outs 312 are arranged, so that sufficiently wide webs of material are formed around the respective cut-outs 312 and help to ensure that the cut-outs 312 do not adversely affect the rigidity of the surface regions 313 surrounding these cut-outs 312.

Such surface regions 313 extend, for example, in the case of the central portion 112 in each case between the bead 114 and an upper edge 314, facing away from the roadway, of the wall 72 facing away from the roadway and between the vertical longitudinal center plane VL and the bends 901 or the bends 902 and 903 or, in the case of the lateral branches 152, between the bend 904 and the respective end region 154 as well as the edge 316 facing the roadway and the edge 318 of the branch 152 facing away from the roadway.

In the same way, the base plates 122 of the support elements 54 and 56 are also provided with cut-outs 322 and 324, the respective total extent of which in relation to the extent of the surface region 325 of the respective base plate 122 surrounding them is likewise at most twice the extent of the surface regions 325 surrounding them in the respective direction, in order likewise not to reduce their rigidity.

In addition, cut-outs 326 are also provided in the wall 76 facing the roadway on both sides of the opening 84, the extent of which in the respective direction is also at most twice the extent of the surface region 327 located on the respective side of the opening 84 and surrounding these cut-outs in the respective direction of the wall 76 facing the roadway.

As shown in FIG. 26, the wall 74, facing the vehicle, of the box-shaped structure 70 is also provided with recesses 3321 and 3322, which are arranged symmetrically with respect to the vertical longitudinal center plane VL and which are surrounded by surface regions 334 of the wall 74 facing the vehicle, which in each case extend adjacently to the support elements 54 and 56 up to the vertical longitudinal center plane VL.

In this case, too, the extent of the cut-outs 3321 and 3322 in the respective direction is at most twice that of the surface regions 334 surrounding said cut-outs in the respective direction.

Furthermore, the wall 78 facing away from the roadway is preferably also provided with cut-outs 3361 and 3362 located on both sides of the vertical longitudinal center plane VL, which cut-outs are also located within surface regions 338 of the wall 78 of the box-shaped structure 70 facing away from the roadway that adjoin the support elements 54 and 56.

In this case, too, the extent of the cut-outs 3361 and 3362 in the respective direction is at most twice the extent of the surface region 338 surrounding them in the respective direction.

In addition, further cut-outs can be seen in this exemplary embodiment, for example in the region of the wall portions 134 as well as 136 and 138.

For additional stabilization of the wall 74 facing the vehicle, this wall is also provided with a bead 342 at a spacing from the wall portion 102, which bead serves for additional stability in the region of the wall 74 facing the vehicle adjacent to the opening 84.

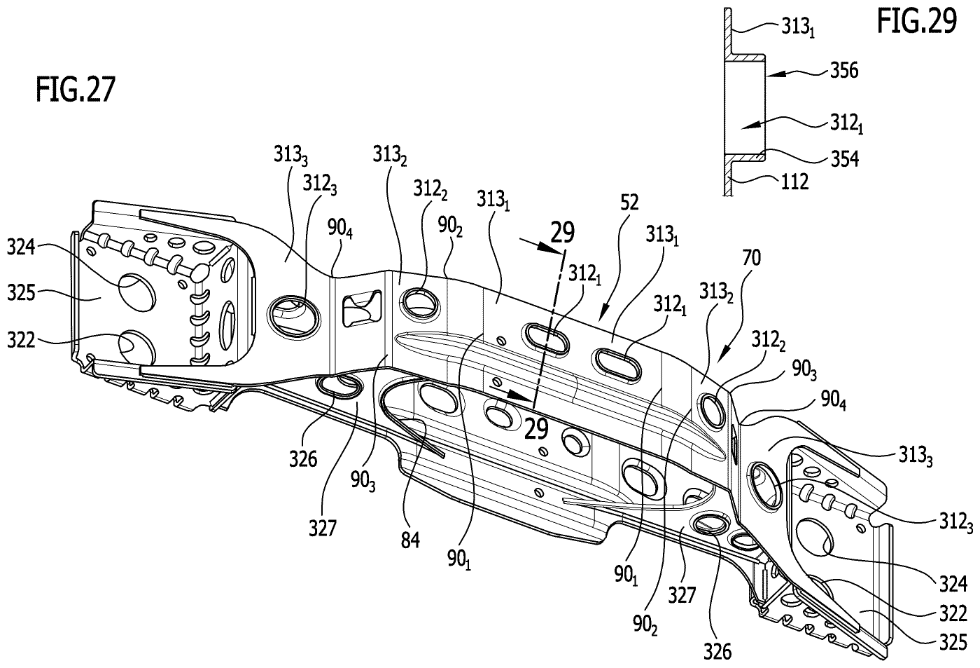

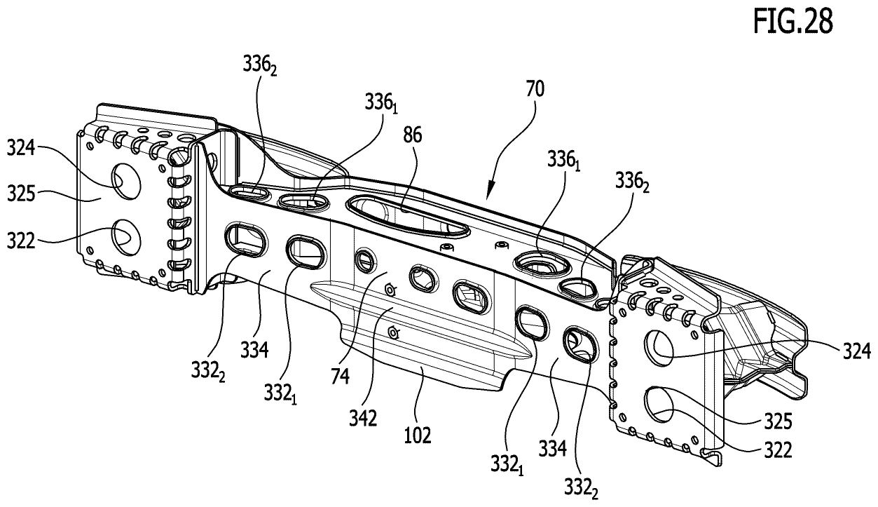

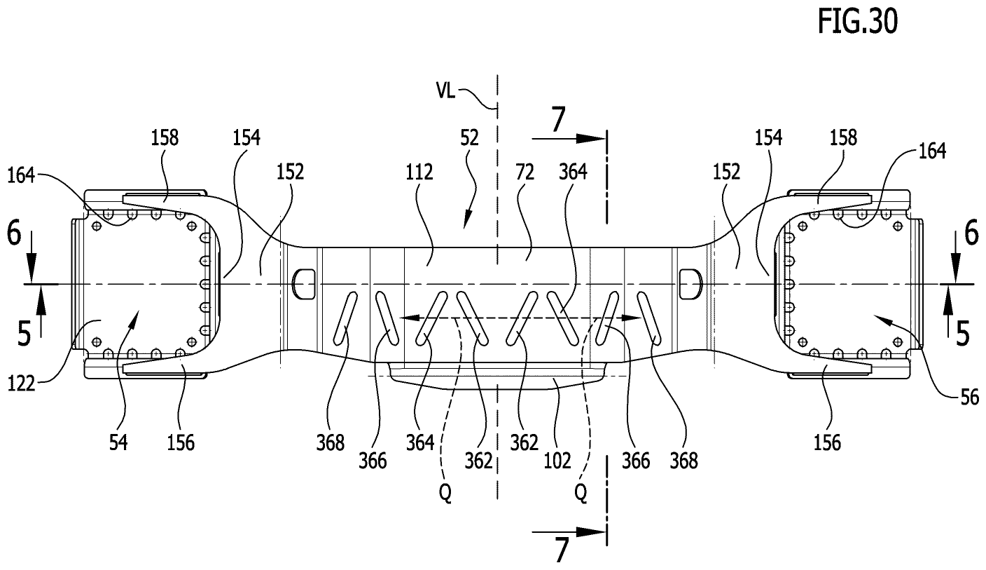

In a third exemplary embodiment, shown in FIGS. 27 to 29, the same cut-outs 312, 326, 332 and 336 are provided in the region of the central unit 52, in particular the box-shaped structure 70, as in the second exemplary embodiment, but all these cut-outs 312, 326, 332, 336, as shown in FIG. 27 using the example of the cut-out 3121, are formed in such a way that, starting from the respective surface region 313, 325, 327, 334, 338 in which the corresponding cut-out, in the case of FIG. 28 for example the cut-out 3121, is arranged, they have reshaped edge regions 354, which run transversely to the respective surface region 3131 and which run in a closed manner around the respective cut-out 3121 (FIG. 29) and thus form a ring body 356 which is integrally molded on the respective cut-out 3121 and has a height extent which runs transversely to the surface region 3131 and corresponds to at least twice the thickness of the surface region 3131, even better at least three times the thickness of the surface region 3131, so that the respective ring body 356 contributes to a significant improvement in the torsional rigidity of the respective surface region 3131 of the corresponding wall, in this case the wall 72 of the box-shaped structure 70, which thus has an effect in all regions of the box-shaped structure 70.

For example, this makes it possible to form the box-shaped structure 70 from a material with a lower material thickness, for example less than 4 mm, preferably approximately 3 mm and less, wherein in this case, for example, the tensile strength of the material is in the range between 500 and 800 MPa.

In a fourth exemplary embodiment according to FIG. 30, instead of the bead 114, beads 362, 364, 366, 368 are provided in the wall 72 facing away from the vehicle on both sides of the vertical longitudinal center plane VL and are arranged in succession in a transverse direction Q relative to the vertical longitudinal center plane VL and run starting from the vertical longitudinal center plane with an alternating inclination relative to one another, in particular run along a zigzag line on both sides of the vertical longitudinal center plane, wherein the zigzag lines run symmetrically on either side of the vertical longitudinal center plane VL.

Such beads can also be provided in the wall 74 facing the vehicle and/or the wall 76 facing the roadway or the wall 78 facing away from the roadway.

In general, such beads 362, 364, 366, 368 increase the deflection resistance of the respective wall 72, 74, 76, 78 and make it possible, for example, to use high strength sheet material with a thickness of 3 mm or less.

Otherwise, the structure of the central unit 52 in the second, third and fourth exemplary embodiment is identical to the structure of the first exemplary embodiment described above, so that, in addition to the explanations given above, reference can be made in full to the explanations relating to the first exemplary embodiment.

1. An impact-absorbing cross member which is mountable under a bumper unit of a vehicle body on a rear region thereof, wherein the cross member extends in a transverse direction running parallel to the bumper unit and has support elements arranged at the ends for support on side regions of the vehicle body, and wherein the support elements are connected to one another by a central unit of the cross member, wherein side impact elements are provided on both sides of the central unit so as to be movable relative thereto, said side impact elements being supported on the support elements of the cross member by impact energy absorption elements.

2. The cross member in accordance with claim 1, wherein the impact energy absorption elements have pre-formed wall elements extending in a direction of extent from the respective support element to the corresponding side impact element, which wall elements are foldable for impact energy absorption.

3. The cross member in accordance with claim 2, wherein wall elements of the impact energy absorption elements have a pre-stamping in such a way that these fold along pre-formed folds for impact energy absorption, which folds extend transversely to the direction of extent of the impact energy absorption elements.

4. The cross member in accordance with claim 1, wherein the impact energy absorption elements are configured to at least partially surround a central axis parallel to the direction of extent.

5. The cross member in accordance with claim 4, wherein the impact energy absorption elements have a closed peripheral form around the central axis parallel to the direction of extent.

6. The cross member in accordance with claim 1, wherein the impact energy absorption elements for supporting the side impact elements have an impact-side cross-sectional area which is smaller than a support-side cross-sectional area provided for the support on the support elements.

7. The cross member in accordance with claim 1, wherein the impact energy absorption elements are configured to taper in their direction of extent from the respective support element to the respective side impact element.

8. The cross member in accordance with claim 1, wherein the side impact elements, in a pre-impact position, are movably supported relative to the central unit.

9. The cross member in accordance with claim 8, wherein the side impact elements are movably supported for support on the central unit by way of an articulated connection, comprising in particular on the one hand an extension and on the other hand a receptacle.

10. The cross member in accordance with claim 9, wherein the extensions, in the pre-impact position, are secured in the receptacles against leaving the receptacles.

11. The cross member in accordance with claim 1, wherein each of the side impact elements extends in the transverse direction over at least one quarter of the total extent of the cross member in the transverse direction.

12. The cross member in accordance with claim 1, wherein each of the side impact elements extends in the transverse direction over a maximum of half the total extent of the cross member in the transverse direction.

13. The cross member in accordance with claim 1, wherein each of the side impact elements is provided with beads running in the transverse direction.

14. The cross member in accordance with claim 1, wherein the support elements have support surfaces for the impact energy absorption elements which are at a spacing of less than 10 mm from body support surfaces of the support elements by which these are supported on the side regions of the vehicle body.

15. The cross member in accordance with claim 1, wherein the support surfaces for the impact energy absorption elements and the body support surfaces of the support elements are arranged on opposite sides of the support elements.

16. The cross member in accordance with claim 14, wherein the support surfaces of the support elements for the impact energy absorption elements and the body support surfaces of the support elements are arranged on opposite sides of a base plate of the support elements.

17. The cross member in accordance with claim 1, wherein the support elements have stabilizing elements outside the support surfaces for the impact energy absorption elements, which stabilizing elements improve the dimensional stability.

18. The cross member in accordance with claim 17, wherein the stabilizing elements have webs extending transversely to the support surface.

19. The cross member in accordance with claim 17, wherein the stabilizing elements are formed as wall portions extending transversely to the support surface.

20. The cross member in accordance with claim 17, wherein the stabilizing elements are formed in one piece on the base plate, in particular by bending.

21. The cross member in accordance with claim 18, wherein the webs extending transversely to the support surface extend, starting from a side facing away from the central body, in the direction of the central unit with increasing extent transversely to the support surface.

22. The cross member in accordance with claim 17, wherein the stabilizing elements extending transversely to the support surfaces are formed integrally with the base plate forming the support surface and the body support surface.

23. The cross member in accordance with claim 22, wherein at least some of the stabilizing elements are connected to each other.

24. The cross member in accordance with claim 1, wherein the central unit comprises a box-shaped structure.

25. The cross member in accordance with claim 24, wherein some of the stabilizing elements of the support elements are connected to walls of the box-shaped structure of the central unit.

26. The cross member in accordance with claim 25, wherein the interconnected stabilizing elements are connected to walls of the box-shaped structure.

27. The cross member in accordance with claim 24, wherein the box-shaped structure of the central unit has a wall facing the vehicle and a wall facing away from the vehicle, as viewed in the direction of travel.

28. The cross member in accordance with claim 24, wherein the box-shaped structure of the central unit has a wall facing away from the roadway.

29. The cross member in accordance with claim 24, wherein the box-shaped structure of the central unit has a wall facing the roadway.

30. The cross member in accordance with claim 1, wherein the box-shaped structure comprises at least one wall provided with at least one cut-out.

31. The cross member in accordance with claim 1, wherein the at least one cut-out has an areal extent which corresponds in each direction to a maximum of 2 times the areal extent of a surface region surrounding it in the respective direction.

32. The cross member in accordance with claim 30, wherein the at least one cut-out is surrounded on all sides by the surface region.

33. The cross member in accordance with claim 30, wherein the at least one cut-out has an outer contour with at least one of i) a substantially round basic shape and ii) a substantially oval basic shape.

34. The cross member in accordance with claim 30, wherein the at least one cut-out has an edge region which, in relation to the surface region surrounding said cut-out, is raised relative to this surface region.

35. The cross member in accordance with claim 34, wherein the raised edge region has a height transverse to the surface region surrounding it which corresponds to at least twice the material thickness of the surface region surrounding it.

36. The cross member in accordance with claim 24, wherein at least a part of the walls of the box-shaped structure has an increased rigidity against deformation as a result of having been reshaped.

37. The cross member in accordance with claim 36, wherein at least one of the walls of the box-shaped structure has a bending line running parallel to the vertical longitudinal center plane.

38. The cross member in accordance with claim 36, wherein at least one of the walls has at least one stamped bead.

39. The cross member in accordance with claim 38, wherein at least one of the walls has at least one stamped bead which extends in the transverse direction to the vertical longitudinal center plane.

40. The cross member in accordance with claim 38, wherein at least one of the walls has successively arranged stamped beads in the transverse direction of the box-shaped structure.

41. The cross member in accordance with claim 38, wherein the beads run inclined to the vertical longitudinal center plane.

42. The cross member in accordance with claim 41, wherein successive beads run transversely to one another in the transverse direction to the vertical longitudinal center plane.

43. The cross member in accordance with claim 1, wherein the central unit is formed in such a way that an attachment element for a trailer or a load carrier is mountable on it and that the forces transmitted by the attachment element to the central unit are transmitted from the central unit to the support elements and from these to the side regions of the vehicle body.

44. The cross member in accordance with claim 43, wherein the box-shaped structure of the central unit carries a receiving unit for the attachment element.

45. The cross member in accordance with claim 44, wherein the receiving unit for the attachment element is arranged in the central unit.

46. The cross member in accordance with claim 43, wherein the receiving unit for the attachment element is arranged in an interior space of the central unit.

47. The cross member in accordance with claim 46, wherein a wall of the central unit facing the roadway has an opening, through which the attachment element with the receiving unit is insertable.

48. The cross member in accordance with claim 43, wherein the attachment element in its working position extends through the opening.

49. The cross member in accordance with claim 43, wherein the attachment element is arranged substantially in the interior space of the box-shaped structure of the central unit in a rest position.
